(19) United States
(12) Patent Application Publication
(10) Pub. No.: US 2018/0292573 A1
(43) Pub. Date: Oct. 11, 2018

(54) Corrective Ensemble Forecasting System for Tropical Cyclones

(71) Applicant: Weather Analytics LLC, Dover, NH (US)

(72) Inventors: Stefan Francis Cecelski, Odenton, MD (US); Leigh Ann Munchak, Silver Spring, MD (US); Sean Tyler Daigneault, Dover, NH (US)

(21) Appl. No.: 15/666,959

(22) Filed: Aug. 2, 2017

Related U.S. Application Data
(60) Provisional application No. 62/481,827, filed on Apr. 5, 2017.

(51) Int. Cl. G01W 1/10; G06F 17/30

(52) U.S. Cl. CPC G01W 1/10; G06F 17/30371

(57) ABSTRACT

A method is disclosed that includes receiving, at a computer-based tropical cyclone ensemble forecasting system (TCEFS), a plurality of storm forecasts from different storm forecasting agencies, receiving, at the TCEFS, storm-related metadata, pairing the storm-related metadata to the plurality of storm forecasts, adjusting the storm forecasts based on the paired storm-related metadata and other forecast data, producing an ideal blended storm forecast based on the corrected storm forecasts, and enabling a user to view and/or access information about at least the ideal blended storm forecast at a user interface.

### CROSS-REFERENCE TO RELATED APPLICATION(S)

This application claims priority to U.S. provisional patent application Ser. No. 62/481,827, entitled Corrective Ensemble Forecasting System for Tropical Cyclones, which was filed on Apr. 5, 2017. The subject matter of the prior application is being incorporated herein by reference in its entirety.

### FIELD OF THE INVENTION

This disclosure relates to a storm forecasting system and, more particularly, relates to a corrective ensemble forecasting system for tropical cyclones.

### BACKGROUND

The weather impacts everything—from underwriting property and insuring against rainfall, to forecasting crop yields and planning exercises for national security. Yet, attempts to mitigate the impact of weather across operations and assets are spotty and often incomplete.

Government agencies tasked with collecting and storing weather data for the public good offer no solution-ready answers for risk managers, claims adjusters, business analysts, and everyone in between.

### SUMMARY OF THE INVENTION

In one aspect, a method is disclosed that includes receiving, at a computer-based tropical cyclone ensemble forecasting system (TCEFS), a plurality of storm forecasts from different storm forecasting agencies, receiving, at the TCEFS, storm-related metadata, pairing the storm-related metadata to the plurality of storm forecasts, adjusting the storm forecasts based on the paired storm-related metadata and other forecast data, producing an ideal blended storm forecast based on the corrected storm forecasts, and enabling a user to view and/or access information about at least the ideal blended storm forecast at a user interface.

Typically, the forecasts are adjusted based on other forecast information, in addition to being corrected at the initialization time, forecast hour 0, using the metadata. In such implementations, the metadata assignments enable homogenization of multiple forecast agencies' data into a singular, usable format. Then, the differences of the forecasts per forecast agency at forecast hour 0 are assessed in comparison to the active tropical cyclone (TC) metadata and adjusted accordingly.

In a typical implementation, each storm forecast represents a weather prediction derived from initial conditions created by the agencies using available meteorological observational data to that agency at the start of forecast integration, and each item of the storm-related metadata represents an actual measurement or observation of a real-world event (e.g., a wind speed, a pressure reading, etc.) that has occurred.

In another aspect, a computer-based tropical cyclone ensemble forecasting system (TCEFS) is configured to receive storm forecasts from the source (or sources) of storm forecasts and storm-related metadata from the source (or sources) of storm-related metadata. The TCEFS has a computer-based processor, and a computer-based memory coupled to the computer-based processor. The computer-based memory stores instructions which, when executed by the computer-based processor, cause the computer-based processor to: pair the storm-related metadata to the plurality of storm forecasts; adjust the storm forecasts based on the paired storm-related metadata and other forecast data (as mentioned previously, typically, the metadata only provides a singular correction at forecast hour 0, with additional correction factors applied using other, independent meteorological forecasts of a tropical cyclone); produce an ideal blended storm forecast based on the corrected storm forecasts; and enable a user to view and/or access information about at least the ideal blended storm forecast at one or more of a plurality of computer-based user interfaces. Each storm forecast represents a weather prediction created by integrating a mathematical representation of physical equations governing the atmosphere forward in time from a starting point of initial meteorological conditions, and each item of the storm-related metadata represents an actual measurement or observation of a real-world event that has occurred.

In yet another aspect, a computer-based system for forecasting weather is disclosed. The computer-based system includes a source or sources of storm forecasts from multiple storm forecasting agencies (e.g., a storm forecast distribution repository), a source or sources of storm-related metadata of actual weather-related observations or measurements (e.g., an active tropical system metadata repository), a computer-based tropical cyclone ensemble forecasting system (TCEFS) configured to receive storm forecasts from the source of storm forecasts and storm-related metadata from the source of storm-related metadata, and one or more computer-based user interfaces to access data from the computer-based tropical cyclone ensemble forecasting system. The TCEFS includes a computer-based processor, and a computer-based memory that stores instructions which, when executed by the computer-based processor, cause the computer-based processor to: pair the storm-related metadata to the plurality of storm forecasts, adjust the storm forecasts based on the paired storm-related metadata and other forecast data, produce an ideal blended storm forecast based on the corrected storm forecasts, and enable a user to view and/or access information about at least the ideal blended storm forecast at one or more of the computer-based user interfaces. Each storm forecast represents a weather prediction created by integrating a mathematical representation of physical equations governing the atmosphere forward in time from a starting point of initial meteorological conditions, and each item of the storm-related metadata represents an actual measurement or observation of a real-world event that has occurred.

In some implementations, one or more of the following advantages are present. In typical implementations, the systems and techniques disclosed herein provide reliable, rationalized, gap-free weather data. By leveraging the world's best information, processed to ensure high quality output, the systems and techniques may provide rich, predictive insights not previously available. The processing can be done quickly and provide real time or near real time forecast information. The systems and techniques may enable a user to access an enormous amount of data—both corrected and ideal, as well as raw data. Additionally, the systems and techniques disclosed herein may provide for the simplification and reduction of a large quantity of data into actionable information.

Other features and advantages will be apparent from the description and drawings, and from the claims.

### BRIEF DESCRIPTION OF THE DRAWINGS

FIG. 1 is schematic representation of an exemplary system configured to facilitate and perform tropical cyclone ensemble forecasting.

FIG. 2 is a more detailed schematic representation of the system in FIG. 1 detailing work flow and associated modules of an exemplary tropical cyclone ensemble forecasting system.

FIG. 3 is a partial schematic representation of the system in FIG. 1 with details about an exemplary ensemble forecast system collector and processor.

FIGS. 4A-4D is a flowchart of a process that may be implemented by an exemplary tropical cyclone ensemble forecasting system.

FIG. 5 is a partial schematic representation of the system in FIG. 1 with details about an exemplary ensemble forecast wind speed and precipitation footprint creator and associated workflow.

FIGS. 6-11 are exemplary screenshots of a graphical user interface for the system in FIG.

FIGS. 12A-12E are partial schematic representations of the system in FIG. 1 showing data flow at various points in the system.

Like reference numerals refer to like elements.

### DETAILED DESCRIPTION

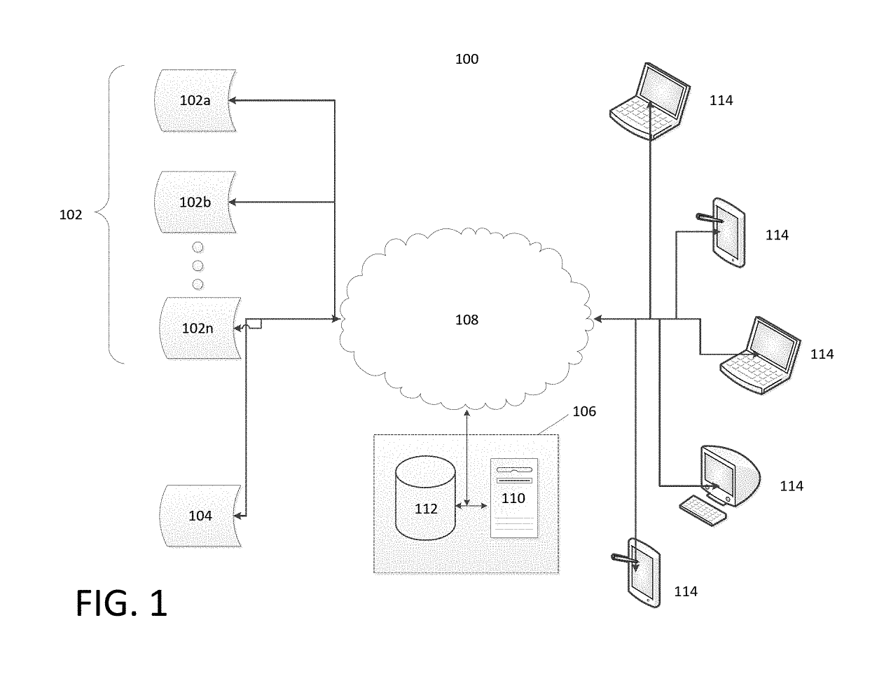

FIG. 1 is schematic representation of an exemplary system 100 configured to facilitate and perform tropical cyclone ensemble forecasting.

The system 100 has sources (102, 104) of weather-related data (including metadata), an exemplary tropical cyclone ensemble forecasting system (TCEFS) 106, and a plurality of user terminals 114—all coupled together as shown via a network 108 (e.g., the Internet). Metadata is a type of data that describes or gives information about other data. Some examples of metadata in the context of weather might include storm names and characteristics including location, wind speed, central minimum pressures and the like.

The system 100 is generally configured to aggregate disparate weather-related data from the various input sources, process the disparate data so that it can be effectively leveraged to create an ideal (e.g., significantly improved) blended forecast based on the aggregated data. The system 100, moreover, may apply various intensity corrections (e.g., to the minimum central pressure and/or maximum wind speed) in the aggregated forecasting data. The system 100 also produces output (e.g., at a graphical user interface or the like) that is highly useful and user-friendly.

The illustrated system 100 includes several sources of weather-related data including a storm forecast distribution repository 102 and an active tropical system metadata repository 104. In a typical implementation, the storm forecast distribution repository 102 has computer-based storage capabilities that can store storm forecast data from several different storm forecasting agencies 102a, 102b . . . 102n. In a typical implementation, the active tropical system metadata repository 104 has computer-based storage capabilities with actual observed (e.g., by a human or machine) storm-related metadata.

The sources of weather-related data 102 and 104 in the illustrated implementation are coupled to a network 108. The network 108 can be virtually any kind of network of computers and/or computer-based equipment, such as the Internet, that enables the flow of information between the various system 100 components, such as the weather-related data sources 102 and 104 and the other system components (e.g., the TCEFS 106, and/or the computer-based user interface devices 114).

The TCEFS 106 is coupled, via the network 108, to the various sources 102, 104 of storm forecasting data. The TCEFS 106, in the illustrated implementation, has both processing (110) and memory storage (112) capabilities/modules. In various implementations, the processing module can include any number of (one or more) processors to perform and/or facilitate the various processing functionalities disclosed herein as being attributable to or for the TCEFS 106. Likewise, in various implementations, the memory storage module 112 can include any number of (one or more) memory storage devices configured to perform or facilitate one or more of the memory storage functionalities disclosed herein as being attributable to or for the TCEFS 106. The processing functionalities and/or the memory storage functionalities can be distributed geographically across different locations.

The computer-based user interface devices 114, such as laptops, tablets, desktops, etc., are coupled, via the network 108, to the TCEFS 106 and, in some implementations, to one or more (or all) of the sources of weather-related data 102, 104.

According to the illustrated implementation, the TCEFS 106 receives data and metadata from the storm forecast distribution repository 102 and from the active tropical system metadata repository 104. This data and metadata can be disparate (e.g., essentially different in kind; and not allowing easy comparison) in nature, with differences from source-to-source in storm naming, data file formatting, file types used, forecast dissemination scheduling, time-stamping, etc. The disparate nature of this data has historically presented a significant barrier in leveraging the data to produce better (e.g., more accurate) tropical cyclone forecasting.

The disparate nature of the weather-related data and metadata may exist for a variety of reasons. One such reason is that governmental agencies and private entities that typically generate this kind of data and metadata tend to maintain their own forecasting platforms.

Moreover, across the globe, there are several meteorological naming conventions for tropical cyclones that exist by ocean basin. The naming of a tropical cyclone is generally implemented by whatever governmental organization is overseeing tropical cyclone activity for that particular basin. In general, that governmental organization would determine when a particular tropical system becomes a named system (such as a hurricane) and/or when to change intensity classifications (e.g., from tropical depression to tropical storm). The official naming can happen anytime, while, in general, ensemble forecasts for tropical cyclones tend to be run on a set schedule each day. This often results in forecasting system misnaming, or missing the name of a tropical cyclone in disseminated forecasting information. Thus, there could be a risk, which the TCEFS overcomes, in using the forecast data “as-is,” as doing so might result in mismatched tropical cyclone forecasts when being blended with other ensemble prediction system forecasts.

Beyond storm naming differences, agencies commonly disseminate their ensemble tropical cyclone forecast data in different data file types using different meteorological naming and unit conventions. This can result in several forecast datasets that are dissimilar for the same storm and that cannot be blended together easily (e.g., without several data manipulation and processing steps, which the TCEFS 106 can perform).

Beyond these difficulties, a fundamental hurdle to blending ensemble predictions is that one or more of the predictions systems may have deficiencies. These deficiencies can result in tropical cyclone forecasts that tend to under-represent (or over-represent) tropical cyclone intensity, for example, based on a tropical cyclone's central minimum pressure and/or maximum near-surface sustained wind speed.

In various implementations, the system 100, including the TCEFS 106, and associated techniques and technologies are well suited to overcome some (or all) of these difficulties by homogenizing disparate forecast datasets, aggregating them, correcting for various forecasts intensity predictions, and then blending them together to produce a superior (e.g., more accurate) forecast of tropical cyclone activity.

The illustrated TCEFS 106 is particularly suited to forecast tropical cyclones. However, the systems and methods disclosed herein may be adaptable to other similar types of weather systems.

Generally speaking, a tropical cyclone is a cyclonic rotating storm system characterized by a low-pressure center, a closed low-level atmospheric circulation, strong winds, and a spiral arrangement of thunderstorms that tend to produce heavy rain. Some examples of tropical cyclones include hurricanes, typhoons, tropical storms, and tropical depressions. Tropical cyclones typically form over large bodies of relatively warm water (typically always above 26.5 degrees Celsius), and generally in the latitude ranges of 10 to 30 degrees. They can derive their energy from evaporation of relatively warm water, which ultimately re-condenses into clouds and rain when the resulting moist air rises and cools to saturation. The strong rotating winds of a tropical cyclone typically result from the angular momentum imparted by the Earth's rotation as air flows inwards toward the axis of rotation. Tropical cyclones are typically between 100 and 2,000 km (62 and 1,243 mi) in diameter. In addition to strong winds and rain, tropical cyclones are capable of generating high waves, damaging storm surge, and tornados. They typically weaken rapidly over land where they are cut off from their primary energy source.

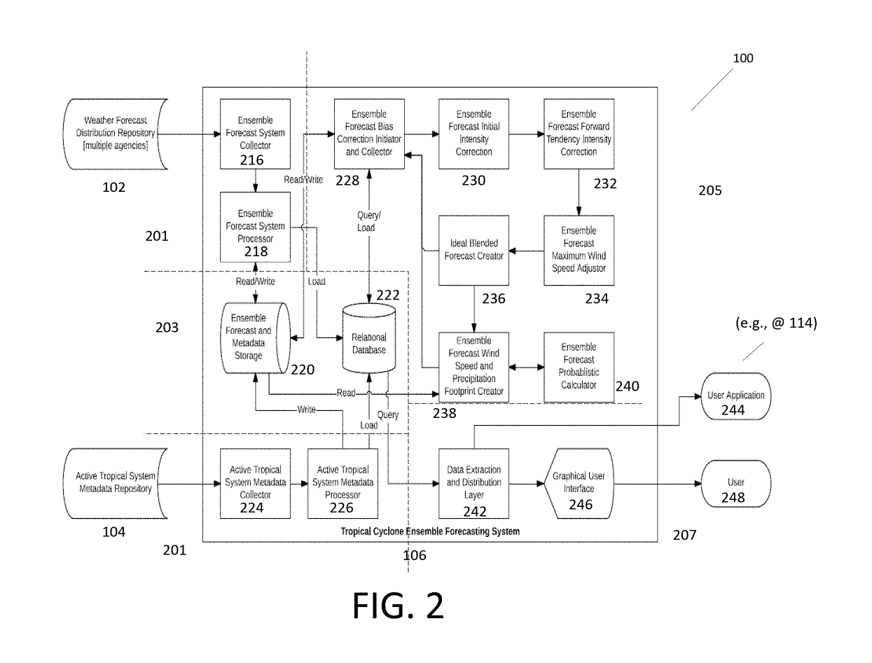

FIG. 2 is a schematic representation of the system 100 of FIG. 1 that includes additional details about a particular exemplary implementation of the Tropical Cyclone Ensemble Forecasting System (TCEFS) 106 of FIG. 1 and some of its internal functionalities (as implemented, for example, by the system's processing 110 and/or memory storage 112 functionalities/modules).

The illustrated components of the exemplary TCEFS 106 may be conceptually organized into a data input layer 201, a storage layer 203, a forecasting layer 205, and a data output layer 207.

The data input layer 201 in the illustrated implementation includes an ensemble forecast system collector 216, an ensemble forecast system processor 218, an active tropical system metadata collector 224, and an active tropical system metadata processor 226.

The storage layer 203 in the illustrated implementation includes an ensemble forecast metadata storage 220 and a relational database 222.

The forecasting layer 205 in the illustrated implementation includes an ensemble 228 ensemble forecast bias correction initiator and collector 228, an ensemble forecast initial intensity correction module 230, an ensemble forecast forward tendency intensity correction module 232, an ensemble forecast maximum wind speed adjustor 234, an ideal blended forecast creator 236, an ensemble forecast wind speed and precipitation footprint creator 238, and an ensemble forecast probabilistic calculator 240.

The output layer 207 in the illustrated implementation includes a data extraction and distribution layer 242 and a graphical user interface 246.

In various implementations, the components of the various layers (201, 203, 205, 207) of the TCEFS 106 can be coupled to one another (e.g., configured to be able to communicate with one another) in any one of a variety of different ways.

According to the illustrated implementation, the ensemble forecast system collector 216 is directly coupled to an external storm forecast distribution repository 102 for weather data from different storm forecasting agencies. A storm forecast distribution repository 102 can be virtually any kind of repository (e.g., computer-based data storage location/module) for weather-related data/metadata, or the like. A few examples of sources for the storm forecast distribution repository 102 include the Global Ensemble Forecast System (GEFS), the Canadian

Meteorological Centre's Ensemble (CMCE), the European Centre for Medium-Range Weather Forecasts (ECMWF), the Hurricane Weather Research and Forecasting (HWRF) model, and the Global Forecasting System (GFS).

Moreover, according to the illustrated implementation, the active tropical system metadata collector 224 is coupled to an external active tropical system metadata repository 104.

In a typical implementation, an external active tropical system metadata depository is a repository (e.g., computer-based data storage location/module) for weather-related data that actually has been observed (e.g., by a human) observing an active tropical storm.

The ensemble forecast system collector 216 may be coupled to one or more external storm forecast distribution repositories 102, and, likewise the active tropical system metadata collector 224 may be coupled to one or more external active tropical system metadata repositories.

The internal components in a TCEFS can be coupled together (e.g., to facilitate communications therebetween) in a variety of different possible. One such way is represented in the implementation represented in FIG. 2.

According to the implementation represented in FIG. 2, the ensemble forecast system collector 216 is internally coupled to the ensemble forecast system processor 218. The ensemble forecast system processor 218 is coupled to both the ensemble forecast and metadata storage module 220 and the relational database 222.

The active tropical system metadata collector 224 is internally coupled to the active tropical system metadata processor 226. The active tropical system metadata processor 226 is coupled to both the ensemble forecast and metadata storage module 220 and the relational database 222.

The ensemble forecast bias correction initiator and collector 228 is coupled to the ensemble forecast and metadata storage 220 and to the relational database 222. The ensemble forecast bias correction initiator and collector 228 is coupled to the ensemble forecast initial intensity correction module 230. The ensemble forecast initial intensity correction module 230 is coupled to the ensemble forecast forward tendency intensity correction module 232. The ensemble forecast forward tendency intensity correction module 232 is coupled to the ensemble forecast maximum wind speed adjustor 234. The ensemble forecast maximum wind speed adjustor 234 is coupled to the ideal blended forecast creator 236. The ideal blended forecast creator 236 is coupled to the ensemble forecast bias correction initiator and collector 228 and to the ensemble forecast wind speed and precipitation footprint creator 238. The ensemble forecast wind speed and precipitation footprint creator 238 is coupled to the ensemble forecast probabilistic calculator 240, to the ensemble forecast bias correction initiator and collector 228, and to the ensemble forecast and metadata storage 220.

The relational database 222 is coupled to the data extraction and distribution layer 242. The data extraction and distribution layer 242 is coupled to an external user application 244 (e.g., one that might be running on one of the computer-based user interface devices 114), and is coupled to a graphical user interface 246. In a typical implementation, the user application 244 and/or the graphical user interface 246 would be configured to provide storm forecasting data (e.g., at a computer-based user interface) for viewing and interaction by a user 248.

In a typical implementation, the ensemble forecast system collector 216 includes several different collector instances and the ensemble forecast system processor 218 includes several different processor instances. An example of this is shown in the schematic representation of

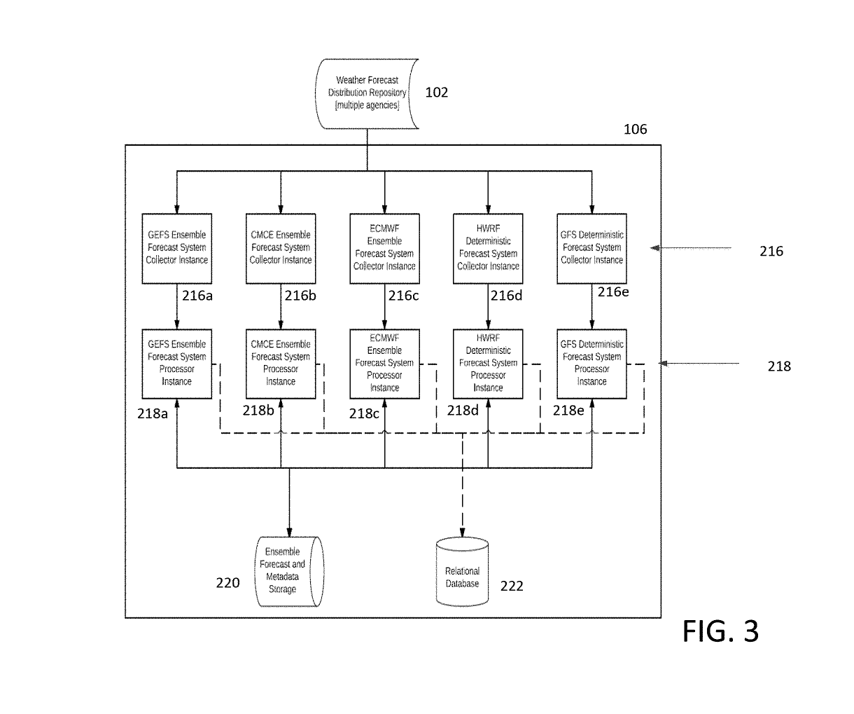

FIG. 3 that shows an exemplary ensemble forecast system collector 216 with several different collector instances 216a-216e and an exemplary ensemble forecast system processor 218 with several different processor instances 218a-218e. Each respective collector instance/processor instance corresponds to a particular one of the sources of data (i.e., agencies or models) for the storm forecast distribution repository 102.

More particularly, in the illustrated implementation, the ensemble forecast system collector 216 includes a Global Ensemble Forecast System (GEFS) ensemble forecast system collector instance 216a, a Canadian Meteorological Centre's Ensemble (CMCE) ensemble forecast system collector instance 216b, a European Centre for Medium-Range Weather Forecasts (ECMWF) collector instance 216c, a Hurricane Weather Research and Forecasting (HWRF) model collector instance 216d, and a Global Forecasting System (GFS) collector instance 216e.

Accordingly, in the illustrated implementation, the ensemble forecast system processor 218 in the illustrated implementation includes a Global Ensemble Forecast System (GEFS) ensemble forecast system processor instance 218a, a Canadian Meteorological Centre's Ensemble (CMCE) ensemble forecast system processor instance 218b, a European Centre for Medium-Range Weather Forecasts (ECMWF) processor instance 218c, a Hurricane Weather Research and Forecasting (HWRF) model processor instance 218d, and a Global Forecasting System (GFS) processor instance 218e.

Each collector instance 216a-216e in the illustrated implementation is coupled to an external storm forecast distribution repository 102. More specifically, each respective collector instance 216a-216e is configured to receive storm forecast data from a corresponding one of the agencies of the storm forecast distribution repository 102. So, for example, the Global Ensemble Forecast System (GEFS) ensemble forecast system collector instance 216a is coupled to receive storm forecast data from the Global Ensemble Forecast System (GEFS) via the appropriate storm forecast distribution repository 102. Likewise, the Canadian Meteorological Centre's Ensemble (CMCE) ensemble forecast system collector instance 216b is configured to receive storm forecast data from the Canadian Meteorological Centre's Ensemble (CMCE) via the appropriate storm forecast distribution repository 102.

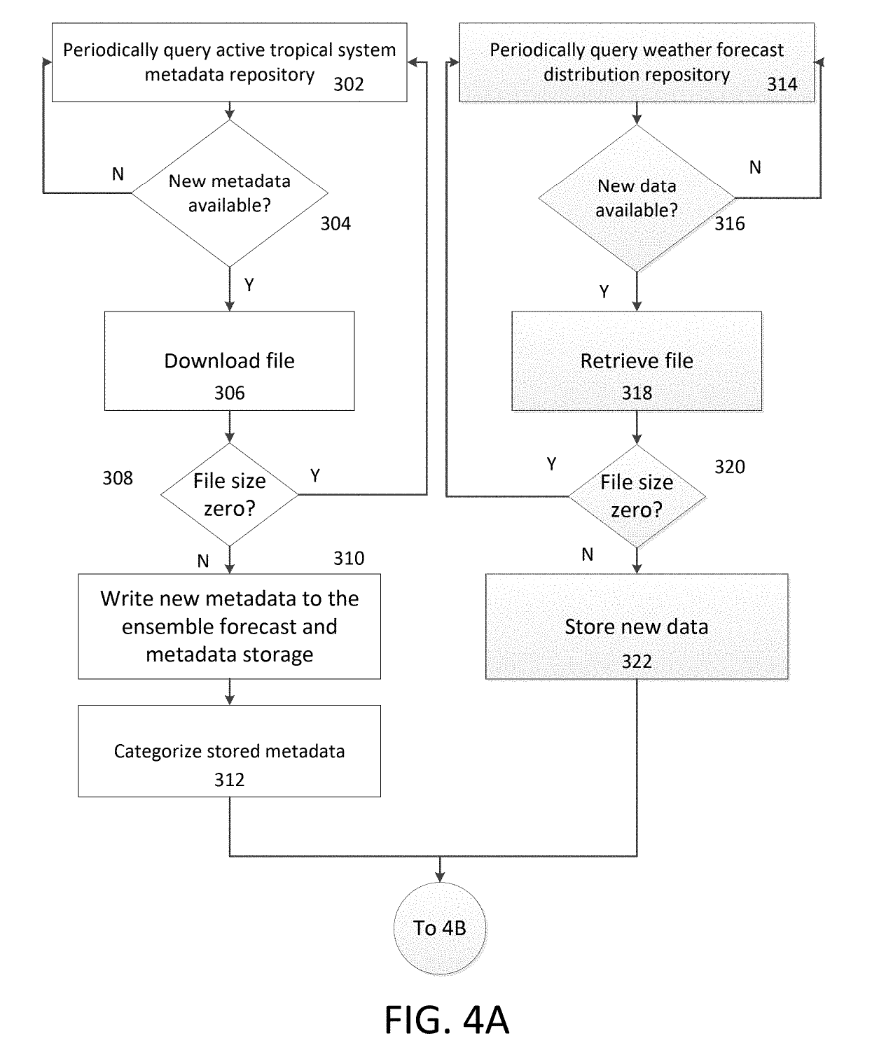

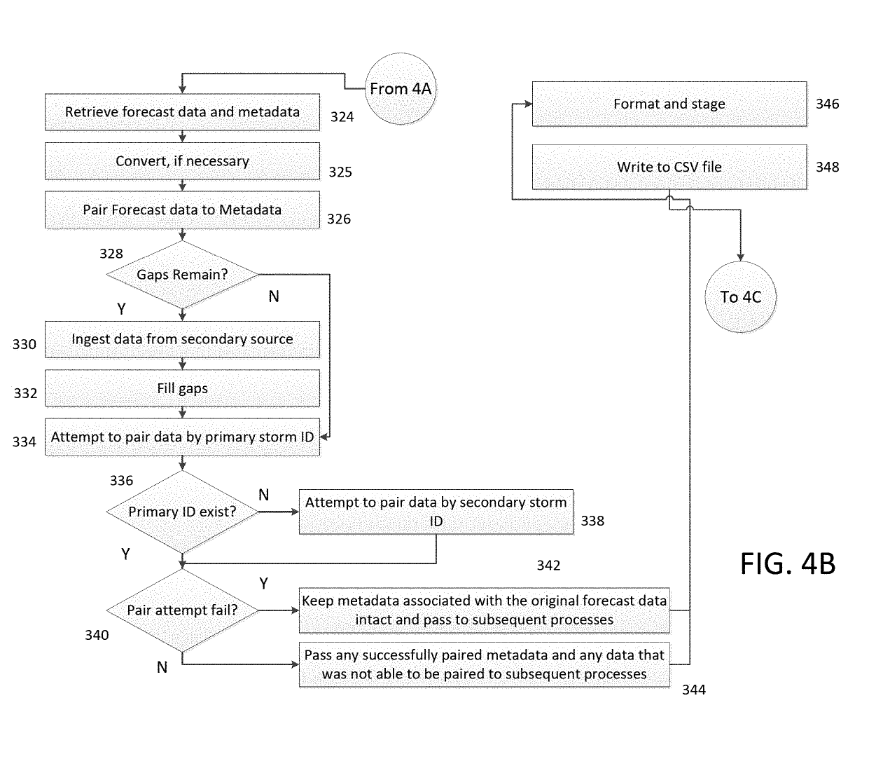

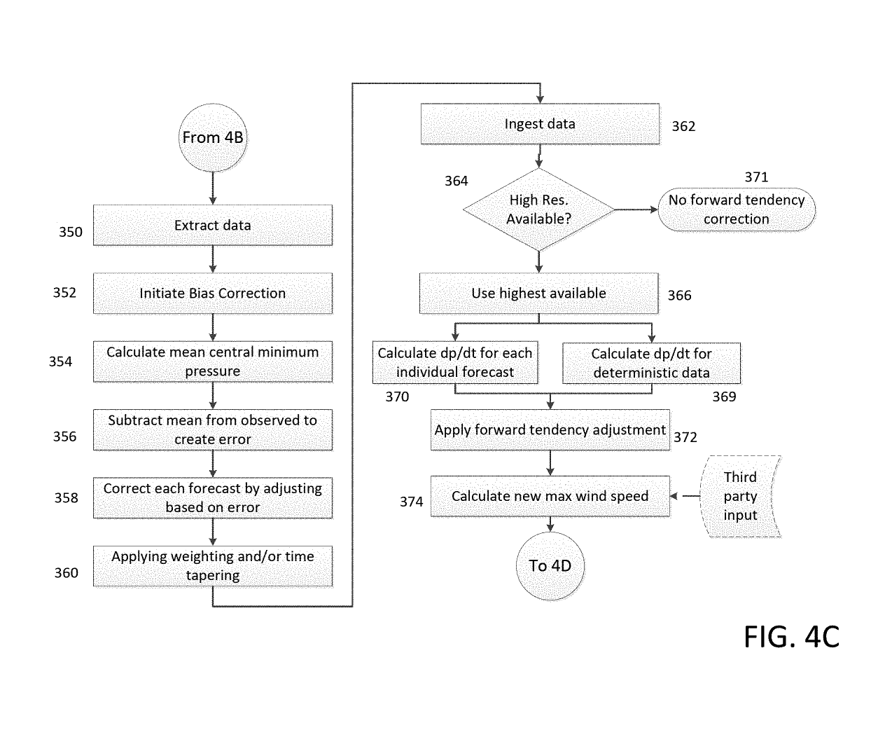

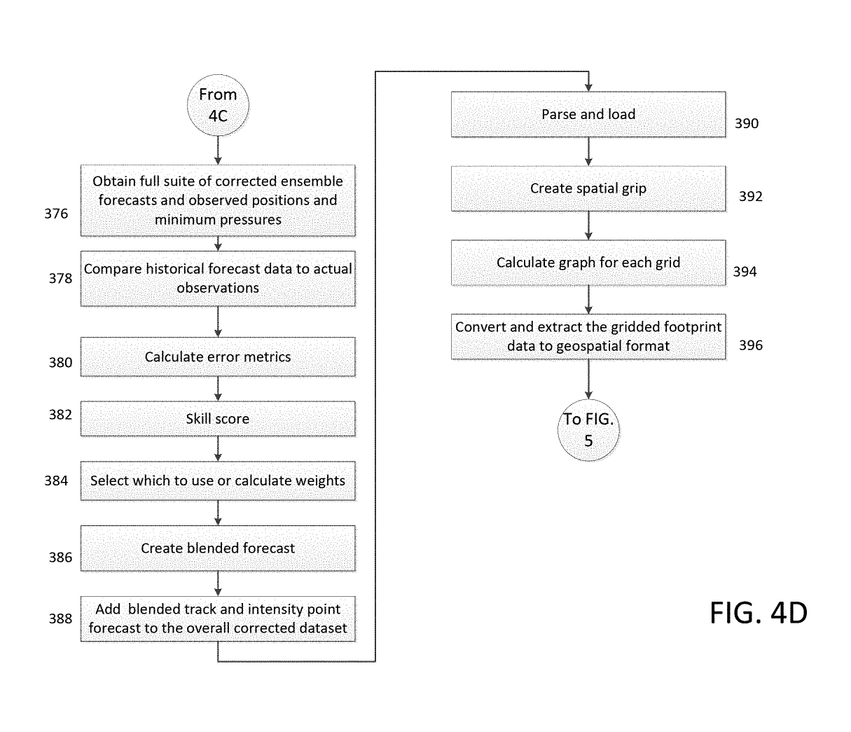

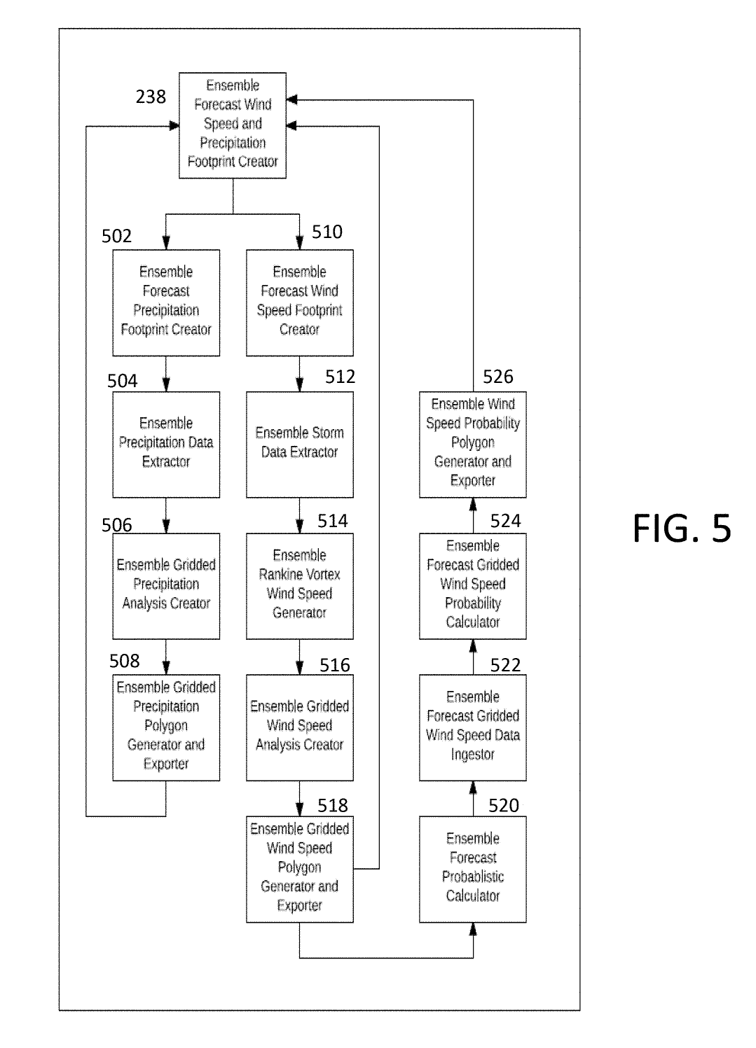

FIG. 4A-4D and 5 are flowcharts/schematic representations of exemplary processes that may be implemented by the system 100 represented in FIGS. 1, 2 and 3.

According to the illustrated flowchart, the active tropical system metadata collector 224 (at 302) periodically queries one or more active tropical system metadata repositories 104 for new data. In various implementations, an active tropical system metadata repository 104 is updated periodically with new data from one or more governmental or private sources that typically includes human-observed storm-related data. These requests may take the form of

Hypertext Transfer Protocol (HTTP) queries over a network (e.g., the Internet), or any other form. The periodic requesting may occur virtually any time or at time intervals (e.g., hourly, daily, weekly, etc.), which may be regular or varying. In one exemplary implementation, the active tropical system metadata collector 224 queries an active tropical system metadata repository 104 (e.g., the publicly-available web server maintained by the National Oceanic and

Atmospheric Administration' (NOAA's) National Weather Center's (NWS) National Centers for Environmental Prediction (NCEP)) four times a day for new tropical system metadata. This metadata may include, for example, new storm names, intensity estimates (e.g., in terms of wind speed and/or central minimum pressure), and/or other storm-related data or metadata.

If, in response to a request, the active tropical system metadata collector 224 determines (at 304) that new metadata may be available at the active tropical system metadata repository 104, then the active tropical system metadata collector 224 (at 306) initiates downloading of the associated file (of new storm-related metadata). The file gets downloaded. In some implementations, the downloaded file or files that include the new storm-related metadata may be in a space-delimited text format. In general, a delimited file is a text file used to store data, in which each line represents a single thing, such as a single storm (or single piece of data about a storm), and each line has fields separated by a delimiter.

Sometimes, the active tropical system metadata repository 104 publishes (i.e., makes available for download by the active tropical system metadata collector 224) a file that is empty (i.e., the file does not include any metadata). To account for this possibility, the active tropical system metadata collector 224 may be configured, as reflected in the illustrated implementation, to check each file as it arrives at the TCEFS 106 from the active tropical system metadata repository 104 to see if that file is empty or not.

If the active tropical system metadata collector 224 determines (at 308) that the size of a particular downloaded file is zero, then the active tropical system metadata collector 224 suspends operations with respect to that file and returns to (302) periodically querying the active tropical system metadata repository 104. If, on the other hand, the active tropical system metadata collector 224 determines (at 308) that the file size for the downloaded dataset is not zero (i.e., that the file does contain data or metadata), then the active tropical system metadata collector 224 (at 310) causes or passes the file along for storage and later use in the ensemble forecast and metadata storage 220.

Generally speaking, and as disclosed herein, the TCEFS 106 is configured to leverage or utilize the data or metadata that it receives (and stores) from the active tropical system metadata repository 104 (and the different weather agencies) to help unify the likely disparate types of weather-related data it receives from the storm forecast distribution repository 102 from the multiple different weather agencies. In some implementations, this may include, for example, leveraging commonalities in the storm forecasts and/or the metadata to eliminate one or more of the disparities (e.g., missing or conflicting data, differences in data formats, etc.). So, for example, if a named storm for one forecast has the same location and estimated intensity (e.g., a minimum central pressure) as another unnamed storm, then the TCEFS 106 may conclude that the forecasts (for the named storm and for the unnamed storm) relate to the same storm. The TCEFS 106 may then combine the data from one forecast with the data of the other forecast, or use the data from one forecast to fill data gaps in the other forecast. Similarly, if there is conflicting data for the same storm in two forecasts, the TCEFS may give precedence to one of the forecasts, or turn to data of yet a third forecast to settle the difference. Additionally, in some implementations, the TCEFS may convert the file formats of one or more pieces of data or metadata to match the file formats of other data or metadata. The end result of these processes is data and/or metadata that is easy to correlate.

Next, according to the illustrated implementation, the active tropical systems metadata processor 226 (at 312) categorizes the stored metadata. In a typical implementation, the categorizations (or categories) may be based on categories specified or selected by a (human) system operator. In this regard, the TCEFS 106 may include or be coupled to one or more computer-based user interface terminals (not shown) that enable a system operator to specify or select data or metadata categories and/or to otherwise interface with and/or leverage the TCEFS 106 functionalities described herein.

In categorizing the stored metadata, the active tropical systems metadata processor 226 typically reads the metadata that has been downloaded and stored in the ensemble forecast and metadata storage 220 and creates a new file storage instance (e.g., in the ensemble forecast and metadata storage 220) for processed (or categorized) metadata. More particularly, in this regard, the active tropical systems metadata processor 226 reads the stored metadata (typically in a delimited text file) into computer random access memory (“RAM”) or some other temporary storage medium, and identifies one or more metadata category for each piece of metadata, based on the categories that have been specified by the system operator. A few examples of possible category names are: date of the analysis, official storm name, storm identifier in the basin, ocean basin identifier, latitude and longitude of the storm, storm's central minimum pressure, storm's maximum sustained wind speed, storm's speed and/or direction, environmental pressure, radius of maximum wind, etc. These are just a few possibilities; other category names (and associated metrics) may be used.

If the retrieved metadata file contains metadata in a line-by-line fashion, such as an NCEP (National Centers for Environmental Prediction) data file, where one line of information represents a single tropical cyclone and its related metadata, the active tropical systems metadata processor 226 goes through each individual line of data in the stored file and reads each line into RAM or some other temporary storage medium, and extracts the characteristics of interest for formatting. The extracted characteristics, regardless of source, are organized on a line-by-line basis to match commonly available sources and written to a new comma-delimited (“CSV”) or other delimited file type in RAM or some other temporary storage medium.

Once the active tropical systems metadata processor 226 reads all the metadata, extracts the identified characteristics, and writes the same to the CSV or other delimited file type in RAM or other temporary storage, the delimited file is closed to further writes and stored in the ensemble forecast and metadata storage 220. Typically, the active tropical systems metadata processor 226 also executes a parse and load of the newly created file into the relational database 222, which in one exemplary embodiment is a PostgreSQL database. In a typical implementation, parsing may refer to, for example, the ingestion and extraction of various columnar components and metadata that make up the CSV for interpretation with the relational database 222. In a typical implementation, load refers to, for example, storing the parsed information in the relational database 222 organizational hierarchy. Again, the relational database 222 may be hosted locally or remotely.

The TCEFS 106 represented in the illustrated implementation is also configured to collect and process data from storm forecast distribution repositories 102, which, in a typical implementation, represent different sources of storm forecast data (e.g., agencies). Referring again to the flowchart in FIG. 4, the process represented therein includes (at 314) periodically querying the storm forecast distribution repositories (multiple agencies) for new storm forecast data.

In this regard, as discussed above with reference to FIG. 3, the TCEFS 106 may have multiple different ensemble forecast system collector instances 216a-216e, each of which may be specifically configured to interact with the appropriate storm forecast distribution repository 102 according to the requirements and/or characteristics of its associated agency. So, for example, the Global Ensemble Forecast System (GEFS) ensemble forecast system collector instance 216a would be specifically configured to interact with the related storm forecast distribution repository 102 according to the requirements and/or characteristics associated with the GEFS. What this means is that the different ensemble forecast system collector instances 216a-216e may behave differently than one another. For example, each instance may be configured to request the source for new data the appropriate number of times per predetermined time windows to ensure detection and then retrieval of available new data on a timely basis. Each instance is also configured to detect and retrieve the appropriate number of data files for the particular source.

For example, in one exemplary embodiment, the ensemble forecast system collector 216 contains GEFS and CMCE collector instances 216a, 216b that both check for tropical cyclone ensemble forecast data from the same NCEP HTTP server, though with different HTTP URL endpoints. These files may be stored on a per ensemble forecast and per forecast cycle basis, meaning that there may be 21 individual files per forecasting system to check for existence on the HTTP server. Thus, the collector instance 216a for the GEFS ensemble forecast system may have 21 files available for download 4 times a day on days with active tropical cyclones. Meanwhile, the ECMWF and CMCE collector instances 216c, 216b may need to query for new data two (2) times a day to stay up-to-date. Additionally, NCEP offers two separate sources of high spatial resolution tropical cyclone forecast data that can be used with intensity bias correction later in the system. One exemplary embodiment thus contains two collector instances for such high-resolution data; each of these may be configured to operate the same as (or different from) the other.

The collection instances detect new data by periodically querying the source as to the existence of new data files. Once an instance receives confirmation of the existence of a new file (at 316), it retrieves the file (at 318) and if the file is not empty (see 320) stores the new file or data locally or remotely as chosen, for example, by the system operator. In one exemplary embodiment, GEFS and CMCE collector instances initiate forecast data file existence checks for each of the 21 potential files available on the HTTP server. Each of these instances periodically ping the HTTP server to check if the requested file is available for download. When the specified file becomes available, each instance initiates a HTTP download request, storing the downloaded files on hard disk storage.

In some implementations, the collection instances 216a-216e are fully configurable based on their corresponding data sources. In one exemplary embodiment, an ECMWF ensemble forecast collector instance can be configured so that it attempts to obtain ensemble forecast data from a FTP server maintained by the ECMWF agency. This FTP server stores files in a different fashion that the other ensemble prediction systems, such that the files are on a per storm basis (if there are active tropical systems), rather than a per ensemble forecast basis. Thus, the ECMWF collector instance periodically checks for existence of storm-based files on the FTP server, and initiates FTP download requests for each file it finds. These files are then stored later use and processing.

Along with ensemble forecast data, the ensemble forecast system collector 216 can include collector instances for retrieval of higher spatial resolution deterministic tropical cyclone forecast data, such as certain files disseminated by NCEP. As with ensemble forecast data collector instances, these instances periodically query the sources of such high-resolution data, detect any new data, retrieve the new data and write it to storage. These collector instances are also fully configurable based on the manner and timing that sources release such data.

As mentioned above, in one exemplary embodiment, the ensemble forecast system collector 216 has two collector instances to collect high spatial resolution deterministic tropical cyclone forecast data contained on NCEP data files. Such files are usually produced on a similar dissemination schedule to the GEFS ensemble data, with forecasts available 4 times a day from the NCEP HTTP server. The first of these high-resolution collector components in one exemplary embodiment downloads tropical cyclone forecast data generated by the Hurricane Weather Research and Forecasting (HWRF) system. This data is stored on the same HTTP server as the other NCEP products, but with a different HTTP endpoint. In a typical implementation, the corresponding collector instance would periodically check for the existence of the most up-to-date forecast files, and downloads them once they become available on the HTTP server. These files may be stored on hard disk storage provided they are not empty (i.e., containing no forecast data due to lack of tropical system activity), see, e.g., 320. The second deterministic collector instance downloads the Global Forecast System (GFS) deterministic tropical cyclone forecast from the same NCEP HTTP server. In similar fashion to the other collector instances, it periodically checks for the existence of recent forecast data, and downloads the data files to hard disk storage when available. In a typical implementation, each collector instance in the ensemble forecast system collector 216 initiates a subsequent processor instance 218 when it collects and writes data to storage. Together the processor instances 218a-218e are referred to herein as the ensemble forecast system processor 218. The workflow of one embodiment of the ensemble forecast system collector 216 and ensemble forecast system processor 218 is shown in FIG. 3, which was described above.

Each processor instance 218a-218e in the illustrated implementation may be configured to extract, format, and/or store collected tropical cyclone ensemble forecasts, such as GEFS, CMCE, ECMWF ensemble forecast files, or high spatial resolution deterministic forecast files (such as those from HWRF or GFS). At the culmination of the ensemble forecast system processor's 218 work, the TCEFS will have a relational database 222 populated with unified raw forecast information ready to be extracted and/or parsed by downstream forecast correction algorithms, etc.

FIG. 4B is a flowchart representing an exemplary implementation of the processes performed by the ensemble forecast system processor 218 (or any one of the ensemble forecast system processor instances 218a-218e) in this regard.

First, according to the illustrated implementation, the ensemble forecast system processor 218 (at 324) retrieves forecast data and metadata from the ensemble forecast and metadata storage 220.

Next, according to the illustrated implementation, the ensemble forecast system processor 218 (at 326) pairs the retrieved forecast data and metadata. Pairing generally refers to the process of attempting to resolve any conflicts, filling in any missing information, and/or consolidating duplicated information among the data and/or metadata stored in the ensemble forecast and metadata storage 220. In a typical implementation, pairing can help correlate storm names, basin identifiers, and/or other metadata to corresponding forecast data, and resolve apparent conflicts between the various stored data. In a typical implementation, the pairing process involves trying to identify common features or characteristics (e.g., locations, basins, basins identifiers names, etc.) across the different data sets to identify which data sets relate to the same tropical cyclone.

In some implementations, the ensemble forecast system processor 218 is configured to resolve any conflicts among the stored metadata in a hierarchal fashion, giving precedence, for example, to any metadata that originated at the active tropical system metadata repository 104 over any metadata that originated at the storm forecast distribution repository 102. Thus, if a conflict were identified (e.g., by the ensemble forecast system processor 218), in this example, the metadata that first entered the ensemble forecast and metadata storage 220 via the active tropical systems metadata processor 226 would get precedence over (and be used to replace) any conflicting metadata that first entered the ensemble forecast and metadata storage 220 via the ensemble forecast system processor 218.

Moreover, in a typical implementation, the ensemble forecast system processor 218 is configured to use the metadata that originated from the active tropical system metadata repository 104 to fill in any gaps (of missing metadata) in the forecast data stored in the ensemble forecast and metadata storage 220.

Additionally, in typical implementation, the ensemble forecast system processor 218 is configured to replace any duplicated metadata in the forecast data stored in the ensemble forecast and metadata storage 220 with metadata that originated from the active tropical system metadata repository 104.

Next, according to the illustrated implementation, if the TCEFS 106 determines (at 328) that any gaps (e.g., conflicting or missing data) remain after implementing one or more (or all) of the foregoing pairing techniques, then the TCEFS 106 (at 330) ingests more data (e.g., from a secondary metadata source), and the ensemble forecast system processor 218 (at 332) uses that additional ingested data to try (at 334) to fill any such gaps. In one exemplary embodiment, such gaps in NCEP data may be plugged or filled from metadata from NOAA's National Hurricane Center (NHC), which, in some instances, may be ingested, for example, from the NHC server during GEFS file processing and passed along to other processing instances via the ensemble forecast and metadata storage device 220.

In some implementations, the specific details of the pairing process applied by the ensemble forecast system processor 218 may depend for example, on the source and type of the forecast data being considered.

For some sources, such as GEFS, CMCE, and GFS, the forecast data collected and stored via the ensemble forecast system collector 216 may have the same text delimited format as the tropical system metadata file(s). In such a case, the ensemble forecast system processor 218 may access the stored data file(s) for the corresponding ensemble processing system, as well as the delimited metadata file(s) from or generated by the active tropical system metadata processor 226 and stored in ensemble forecast and metadata storage 220 (or gap-filling metadata from a secondary source). The ensemble forecast system processor 218 then reads both of these files into RAM or some other temporary storage medium. For forecast data from some data sources, such as GEFS and CMCE, the processor instance (of the ensemble forecast system processor 218) may be capable of processing each individual ensemble forecast file separately, then combining them all into a single CSV forecast data file or other delimited file type for use in downstream processes.

In a typical implementation, the pairing involves using common storm identifiers (IDs), such as ocean basin IDs, storm basin IDs, and/or storm names, and/or the valid forecast dates and times. In this regard, pairing may proceed in a hierarchal fashion, starting, for example, with a primary storm identifier selected or specified by a system operator. In this regard, the TCEFS 106 may include one or more computer-based user interfaces (not shown in FIG. 2) to facilitate, or enable a user to enter, this kind of selection or specification.

In one exemplary embodiment, the ensemble forecast system processor 218 first attempts (at 334) to pair tropical cyclone forecast data and metadata by a primary storm identifier (e.g., storm name and/or storm basin ID). In the unlikely event that a primary storm identifier did not exist in the ensemble forecast metadata storage 220 (see 336), then the ensemble forecast system processor 218 may (at 338) utilize a secondary storm identifier to pair the forecast data to the metadata. In one exemplary embodiment, if neither a storm name nor a storm basin ID exist in the tropical cyclone forecast data, for example, the ensemble forecast system processor 218 may attempt to identify a specific tropical system's forecast data by its ocean basin identifier in combination with a storm name and/or a storm basin ID. If all attempts to pair metadata fail (see 340), the metadata associated with the forecast data file originally remains intact and is passed (342) to subsequent processes with this metadata. Otherwise, any successfully paired metadata and any data that was not able to be paired is passed (344) to subsequent processes.

In a typical implementation, high-resolution deterministic forecast data, such as from HWRF, may be paired with corresponding metadata differently than GEFS, CMCE, and GFS data is paired with corresponding metadata. In this regard, according to an exemplary implementation, a processor instance may extract and manipulate the deterministic forecast data, which is downloaded and stored in the Automated Tropical Cyclone Forecast System (ATCF) guidance comma delimited (A-Deck) file format. This format is like those text delimited formats explained previously, with the data stored by forecast cycle and system. Thus, in an exemplary implementation, the processor instance may recursively go through the forecast file, pairing and/or correcting appropriate metadata. The overall methodology of collecting and pairing metadata may be the same as other instances with the main exception being the initial starting file data format.

The ensemble forecast system processor 218 can also include a conversion step (at 325) before pairing with metadata, if a source, for example, does not provide forecast data in a human readable format.

In such cases, the processor instance may decode the non-human readable data into a human readable format, which is then stored in ensemble forecast and metadata storage 220.

From that storage 220, the processor instance can access the converted forecast data, and assign the appropriate metadata, which is also stored in the ensemble forecast and metadata storage. For example, ECMWF tropical cyclone ensemble forecast data typically would be downloaded in a file format called Binary Universal Form for the Representation of meteorological data (BUFR), which is a binary data format maintained by the World Meteorological Organization (WMO). This file format is not natively human readable, and thus, requires decoders to extract the information into human readable format. In one exemplary embodiment, a processor instance first converts this data into a human readable format by running a BUFR decoder, extracts a human readable formatted text file and writes it to the ensemble forecast and metadata storage 220.

The ensemble forecast system processor's 218 next step (346), in the illustrated implementation, is to format and stage the forecast data (now mated with appropriate metadata) for writing to a CSV or other delimiter-separated value file. The formatting and staging processes can be configured (e.g., by a system operator) based upon type of forecast data. Then, according to the illustrated implementation, the ensemble forecast system processor's 218 (at 348) writes the forecast data (now mated with appropriate metadata) to the CSV or other delimiter-separated value file.

For some types of ensemble forecast data and deterministic forecast data, formatting of the forecast data may include providing or ensuring that the data has proper data header names (e.g., consistent with the metadata naming schema), as well as proper variable formatting and units for meteorological metrics (such as forecast valid time (e.g., time at which a particular forecast is valid), forecast central minimum pressure, and/or forecast maximum sustained wind speed). Once any necessary or desirable formatting changes are made, the merged ensemble forecast data (or deterministic high-resolution forecast data) is written to the ensemble forecast and metadata storage 220 for use with other processes and/or for archival purposes. Finally, each processor instance executes a parse and load of the newly created file into the relational database 222, which, again, may be a PostgreSQL database, in one exemplary embodiment.

Formatting of forecast data that has been converted from non-human readable data, such as from the EMCWF, can include additional steps. For example, first, the processor instance may ingest the converted text file. This processor may work by parsing each text file per tropical system downloaded rather than per ensemble forecast as with the GEFS or CMCE. Additionally, the different decoded text format may require an entirely different formatted read-extract routine as compared to other processors. Reading in each text file per tropical system, the processor instance, which in one exemplary embodiment is the ECMWF processor 218c, extracts the necessary forecast information, including the required metadata to compare with the active tropical system metadata processed in previous steps. The processor 218e then conducts proper formatting changes to the forecast data as previously described, creating a CSV or other delimited file per tropical system that is then written to the ensemble forecast and metadata storage 220. Finally, the processor instance 218c executes a parse and load of the newly created files into the relational database 222.

The ensemble forecast bias correction initiator and collector 228 is configured to collect data and/or metadata from the ensemble forecast and metadata storage 220 and/or relational database and initiate bias correction on that data. FIG. 4C is a flowchart showing an exemplary implementation of some of the processes that may be performed by the ensemble forecast bias correction initiator and collector 228.

The ensemble forecast bias correction initiator and collector 228 directs execution of bias correction components as well as precipitation and wind speed footprint components, then collects the results and loads the bias-corrected ensemble forecast system information into the relational database. Typically, the functions of the ensemble forecast bias correction initiator and collector 228 may be performed as new data becomes available. In a typical implementation, this fast functioning by the ensemble forecast bias correction initiator and collector 228 helps ensure that the data extraction and distribution layer 242 of the data output layer 207 has access to the data it needs and/or uses as soon as possible, thereby mitigating delays in data delivery to users and/or user applications. This substantially immediate access is facilitated by the virtually instantaneous collecting of data and then loading of corrected data by the ensemble forecast bias correction initiator and collector 228 into the relational database as that data is generated. This enables near-real-time data extraction by the data extraction and distribution layer 242 since the data becomes available in the relational database 222 the instant it is loaded by the ensemble forecast bias correction initiator and collector 228.

To initiate the bias correction process, the ensemble forecast bias correction initiator and collector 228 extracts (at 350) all raw tropical cyclone ensemble forecast data to be corrected from the relational database. In one exemplary embodiment, the information that is extracted in this regard is on a per tropical system basis using the common metadata tags assigned in previous steps, such as the storm name and/or forecast initialization time. If the data is extracted using a specified forecast initialization time, the ensemble forecast bias correction initiator and collector 228 generally will extract all available ensemble forecast data valid at the specific forecast initialization time. For example, for 00/12 UTC forecast start times, this data may include data from all GEFS, CMCE, and ECMWF ensemble systems, but for 06/18 UTC forecast start times, this data may include only data from the GEFS system. This gathered ensemble forecast information is passed into the correction processes explained below, with each component typically looping through each active tropical storm and applying its correction procedure.

Next, according to the process represented in the illustrated flowchart, the ensemble forecast initial intensity correction module 230 corrects (352) initial intensity estimates for tropical cyclones in the forecast data.

At the time of forecast start (forecast hour 0), each of the individual ensemble forecasts estimates a central minimum pressure for the tropical cyclone of interest. Due to documented numerical weather prediction model deficiencies, such as coarse spatial resolution, this estimate for central minimum pressure is often different from the observed central minimum pressure, which is contained in the cyclone's metadata file. For each ensemble forecast, the TCEFS 106 and more particularly the ensemble forecast initial intensity correction module 230 of the TCEFS, corrects this central minimum pressure difference in a process called initial intensity correction.

The initial intensity correction generally begins by the ensemble forecast initial intensity correction module 230 looping through the central minimum pressure estimates for all of the ensemble systems passed from the ensemble forecast bias correction initiator and collector 228 (e.g., for GEFS, CMCE, ECMWF) and calculating the mean of the central minimum pressure estimates from the ensemble forecast system's individual members at forecast hour 0. The ensemble forecast bias correction initiator and collector 228 then subtracts (at 356) that mean from the observed central minimum pressure as found in the tropical system's metadata file to create an “error” that is characteristic of each ensemble system's overall initialization error.

The correction process in this regard may take place by looping through each tropical cyclone ensemble forecasting system (e.g., GEFS, CMCE, and ECMWF) and adjusting (358) each individual ensemble forecast for each system utilizing the error calculated above. These adjustments may be weighted and/or time tapered (see 360). For example, in one exemplary embodiment, the magnitude of the central pressure error may be utilized to determine how long the initial intensity correction will take place for each of the individual ensemble forecasts per ensemble system. That is, the larger the ensemble system forecast difference is at forecast hour 0 (from the error), the longer the initial intensity correction will be applied for subsequent forecast hours or time periods. In one exemplary embodiment, the minimum time this correction is applied is 12 hours, or for the first two forecast outputs of each ensemble forecast. The magnitude of the correction may be tapered down to 0 by the end of the initial intensity correction period, such that the full magnitude of initial intensity adjustment is only applied at specified forecast hours. Thus, for each individual ensemble forecast, each forecast hour (out to a 10-day forecast) is applied its appropriate initial intensity correction magnitude, which ranges from the full intensity correction (weight of 1) to no intensity correction (weight of 0).

Notably, the initial intensity correction process does not generally adjust each ensemble member's 0^{th} hour forecast central minimum pressure to the observed central minimum pressure. By maintaining the spread of forecast solutions amongst the individual members (and respective ensemble systems), the adjustment maintains a full complement of meteorologically plausible forecast outcomes.

Once this initial intensity correction is applied on a per ensemble member basis, the updated forecasts (which may be held in RAM or some other temporary storage medium), are passed along to the next module in the forecasting layer 205, which is the ensemble forecast forward tendency correction module 232. The ensemble forecast forward tendency correction module 232 corrects the tendency of tropical cyclone ensemble forecasts to under predict the intensification of a system. This issue may result from the inability of coarser spatial resolution forecasts to resolve meteorological features that lead to intensification, such as eye-wall based convection or eye-wall replacement cycles. Since the intensification of a tropical cyclone can be handled more realistically by higher spatiotemporal numerical weather prediction models, the correction that is performed by the ensemble forecast forward tendency correction module 232 typically includes ingesting (at 362) the data that was collected and processed in previous steps (e.g., from the ensemble forecast system collector 216 and processor 218) and, if possible, applying a time-based pressure tendency correction to each ensemble member forecast of each ensemble prediction system. This process may be referred to generally as forward tendency correction.

In this regard, the forward tendency correction may include determining (at 364) if any high-resolution deterministic tropical cyclone forecast data is available, with preference for the highest spatial resolution available (see 366), which, in one exemplary embodiment, is data from the HWRF forecasting system. If the HWRF forecast data is unavailable for a particular tropical cyclone, for example, the processed deterministic GFS may be used in the time tendency correction (at 368). If (at 364) no high-resolution deterministic tropical cyclone forecast data is available, the no Forward Tendency Correction is applied (see 371), and the rate of intensification in the ensemble forecasts is left unchanged.

To apply an adjustment, according to an exemplary implementation, the high resolution deterministic forecasted central minimum pressure for the requested storm is ingested from the ensemble forecast and metadata storage 220. Using this central pressure information, the TCEFS 106 calculates (at 369) a rate of change in central minimum pressure relative to forecast time (dp/dt) for the deterministic data. The TCEFS 106 calculates (at 370) the same rate change of central pressure with forecast time is also calculated for each individual ensemble forecast.

Looping through each individual ensemble forecast for each ensemble system, the TCEFS (at 372) applies a forward tendency adjustment. Adjustments can be calculated in several different ways. In one exemplary embodiment, if the forecast hour is within the first 48 hours of the forecast, the high-resolution deterministic model rate of change of pressure with time may be averaged with the individual ensemble forecast change of pressure with time. This averaged dp/dt is then applied to the individual ensemble forecasted tropical cyclone, resulting in an intensification rate of the forecasted tropical system that is more intense (and representative) of tropical cyclone intensification processes, while still maintaining the spread of individual ensemble forecast outcomes amongst all of the ensemble systems (and individual forecasts).

Because high-resolution deterministic forecasts generally have the highest skill (relevance) to earlier forecast hours, the TCEFS 106 typically adjusts the forward tendency correction for application to later forecast hours. There are a variety of methods to reflect this drop off in skill level or relevance. In one exemplary embodiment, after forecast hour 48, the forward tendency correction uses progressively less of the high-resolution data as the forecast hour approaches 72. At forecast hour 72, the dp/dt of the individual ensemble member tropical cyclone forecast is 100% that of the ensemble member, with no blend from the high-resolution data existing. Such logic leverages the high-skill forecast period of the high-resolution model (generally highest skill within the first 72 hours of a forecast) while mitigating any skill drop off that occurs as approaching the 72-hour integration time. This methodology can be adjusted as the skill level of high-resolution forecast systems continue to improve with further research and development. Specifically, these skill changes with forecasting lead time in high-resolution forecast systems are being investigated by the governmental hurricane forecasting centers such as NOAA's National Hurricane Center.

Any forward tendency adjustment that is time-limited, like in some exemplary embodiments, may apply a correction factor to ensure the storm's central minimum pressure properly increases (indicating a weakening storm) at a rate indicative of the original individual ensemble forecast's dp/dt beyond a particular forecast hour (e.g., forecast hour 72). Given that the integration length of the high-resolution forecast data utilized is substantially less (72 hours) than that of the 10-day forecast from the individual ensemble member, the influences of the high-resolution data may be completely removed before the final forecast hour. This “weakening storm amplification” factor is applied on a forecast hour by forecast hour basis ensuring that a storm weakens to its expected state of dissipation as defined by the individual ensemble forecast. The factor itself is calculated utilizing the individual ensemble forecast central minimum pressure for forecast hours beyond the time-limited forward tendency adjustment period in comparison to the central minimum pressure at the end of the corrected period. The two variables are blended such that the storm will reach a dissipation stage even after intensity corrections are applied and propagated through the forecast.

The “time-limited forward tendency adjustment period” is the length of time utilized by the forward tendency adjustment. If the system 100 only applies the forward tendency adjustment to improve intensification, the corrected storm will never weaken as it should as defined by the initial ensemble forecast (e.g., after landfall if it occurs within a simulation). So, the system 100 typically takes into account the initial forecasted intensity changes in comparison to the intensity changes as imposed by using the higher resolution data. Thus, the system 100 coerces the forward tendency adjustment data (via the weakening amplification factor) back to the original intensity forecasts post-adjustment period to ensure this weakening is consistent with the individual ensemble forecast.

Once the forward tendency correction is applied to each ensemble forecast member of each ensemble forecasting system for each active tropical system, the updated forecast data is passed to the next correction module, the ensemble forecast maximum wind speed adjustor 234.

The first two procedures of the bias correction process (discussed above) focus on adjusting the central minimum pressure of the individual ensemble forecasts on a per ensemble system and per storm basis. Since storm intensity is commonly expressed in the maximum near-surface wind speed for storm classification purposes, the adjustments applied to the central minimum pressure forecasts may be applied to the maximum sustained wind speed as well.

Using the central minimum pressure-to-maximum near-surface sustained relationship described by Knaff and Zehr (2007) and Courtney and Knaff (2009), the TCEFS 106 (at 374) calculates a new maximum sustained wind speed. This relationship considers the minimum central pressure from the previous correction steps, the forecasted storm motion speed, the forecasted position, and the forecasted environmental pressure. Such parameters as the storm motion speed or forecasted position are not corrected components from the previous steps, but rather, parameters directly from the individual ensemble forecast output. The relationship (between the central minimum pressure-to-maximum near-surface sustained) empirically relates the two parameters to each other by deriving relationship with several estimated metadata values for a particular storm, including latitude of the storm, storm size, and environmental pressure. Using these metadata features in addition to estimated (observed) central minimum pressure, a storm's near-surface maximum sustained wind speed can be calculated.

Environmental pressure can be an important component in the relationship between central minimum pressure and maximum near-surface sustained winds. Environmental pressure may be calculated or obtained from a variety of sources, but optimally will involve a source and data that are not included in the tropical cyclone ensemble forecast suite. By using such an outside source, the operator of the TCEFS 106 can be confident the environmental pressure used is not preferentially influential to any of the individual ensemble forecast members. In one exemplary embodiment, an ancillary data source of mean sea-level pressure (MSLP) is obtained from NCEP-generated Climate Forecast System (CFS) data, which is not included among the different forecast ensembles collected, and is processed by the ensemble forecast system collector 216 and processor 218. The environmental pressure is derived by extracting the CFS forecasted MSLP around each tropical cyclone for every forecast hour of the valid forecast cycle. Using the ring of extracted MSLP points around each tropical system, the environmental pressure is calculated as the median of these points and used in the aforementioned pressure-to-wind relationship.

Like previous correction steps, the procedure loops through each individual forecast member for each forecast hour out to some time period (e.g., to 10 days (or to when the storm ceases to exist in the particular individual ensemble member)), and calculates each component of the relationship between central storm pressure and maximum near-surface sustained winds. Specifically, if the forecast hour is 0, the metadata for storm speed, environmental pressure and radius of maximum wind are used from the active tropical system metadata file (or a secondary gap-filling metadata source if necessary). If the forecast hour is not hour 0, then the storm speed and radius of maximum wind is calculated from the individual ensemble member forecast data while the environmental pressure is retrieved from a source that may have been chosen by the TCEFSE 106 operator, in this case, the CFS median approach described above. Once these components are calculated, the full pressure-to-wind speed relationship is calculated, resulting in a maximum sustained wind speed that is consistent with the corrected minimum central pressure and the other parameters.

At the end of this correction procedure, the individual tropical cyclone ensemble forecast track and intensity corrections are complete, and the fully corrected dataset is passed to the ideal blended forecast creator 236. After correcting the forecasts of each individual ensemble forecast, the TCEFS 106 creates an “ideal” or “best estimate” forecast using historical skill scores for each forecast ensemble and blending them. In general, each “historical skill score” represents (e.g., numerically or otherwise) an accuracy of an individual forecast over a specified date range for predefined criteria, such as intensity or track. In a typical implementation, this “best estimate” forecast represents the most skillful track and intensity forecast for each active tropical cyclone whose forecasts were corrected using the previous methods.

The ideal blended forecast creator 236 begins by obtaining (at 376) a full suite of corrected ensemble forecast data, and a storm's observed positions and central minimum pressures (from the metadata stored in the ensemble forecast and metadata storage 220 or any secondary metadata sources) over some period of time prior to the current active forecast initialization time. One exemplary embodiment gathers such data over the 24-hour period prior to the initialization time. The corrected ensemble forecast data represents “historical” forecast data that can be used in comparison with observed data to infer forecast skill, since the forecast valid time of the forecast data now has matching observational data. Thus, the skill score calculated by the ideal blended forecast creator 236 is different from other commonly used skill score: rather than be based on the skill, or accuracy, of a particular model or ensemble member as measured over many historical storms, the TCEFS 106, through the ideal blended forecast creator 236, calculates skill score based on model or ensemble member performance with the storm of interest.

In an exemplary implementation, for each active storm, the procedure loops through each of the individual ensemble forecast's historical forecast data (the previous 24 hours in one exemplary embodiment) and compares (378) it to the observations of the actual system. From these comparisons, the ideal blended forecast creator 236 (at 380) calculates error metrics. The error metrics can be calculated for any one or more characteristics contained in both the historical forecast data and the observable values contained in the storm's metadata. In one exemplary embodiment, the ideal blended forecast creator 236 calculates central minimum pressure and positional error metrics. The metrics may be stored in RAM or some other temporary storage medium for each individual ensemble forecast, providing (at 382) a storm-by-storm skill score for each ensemble member, as well as for each ensemble system. In a typical implementation, the TCEFS 106 can use the skill score(s) to select (at 384) which of the individual ensemble forecasts or ensemble systems to include in a blended forecast, or to calculate weights to assign each in a blended forecast. The TCEFS 106 then creates (at 386) the blended forecast.

One exemplary embodiment utilizes a double-selection methodology whereby the skill of the individual ensemble forecasts is ranked twice: once by their central minimum pressure skill, and once by their positional skill. The top half of the members from each of these rankings is retained, with the median of the combined remaining members becoming the “best estimate” ensemble forecast. The median is used as the errors for both central minimum pressure and track are assumed to be normally distributed about 0 (units of hPa if pressure, km if track error), and thus there should be an equal number of positive and negative errors. Thus, the median of these represents the error closest to 0 (or highest skill).

The TCEFS 106 (at 388) adds this blended track and intensity point forecast to the overall corrected dataset, then passes back to the ensemble forecast bias correction initiator and collector 228 to parse and load it (at 390) into the relational database 222. Additionally, the complete corrected forecast dataset is passed to the next component of TCEFS 106—the ensemble forecast wind speed and precipitation footprint creator 238, which produces one or more 3-dimensional (space and time) wind and precipitation footprints.

In an exemplary implementation, the ensemble forecast wind speed and precipitation footprint creator 238 uses the corrected track and intensity information in addition to raw derived ensemble forecast output, to create wind speed and precipitation footprints to provide awareness of a tropical cyclone's forecasted spatial extent. The footprints can be generated at regular time intervals (e.g., every forecast hour in one exemplary embodiment) starting with forecast hour 0, with the footprints displaying the most recent forecast valid time in addition to the previous forecast valid times (hence, the “footprint” definition). For example, a 0 to 48-hour wind speed footprint may depict a tropical cyclone's spatial extent of near-surface maximum sustained wind speeds exceeding a specific wind speed magnitudes for all forecast hours between 0 and 48. These footprints can be generated for every individual ensemble forecast member and for every active tropical system.

In a typical implementation, the TCEFS 106, with the ensemble forecast wind speed and precipitation footprint creator 238, generates this information in several steps including: creating a spatial grid (at 392), calculating maxes (or summations) for each spatial grid point around a tropical system (at 394), and, converting and extracting the gridded footprint data to geospatial formats compatible with users and GUIs (at 396). One such format used in an exemplary embodiment is GeoJSON. Specifically, GeoJSON is a format for encoding geographic data structures, which, in the TCEFS 106, serves the purpose of aggregating the geospatial information associated with gridded ensemble forecast information.

FIG. 5 is a schematic representation of an exemplary workflow associated with the ensemble forecast wind speed and precipitation footprint creator 238.

The depicted workflow includes or involves an ensemble forecast precipitation footprint creator 502, an ensemble precipitation data extractor 504, an ensemble gridded precipitation analysis creator 506, and an ensemble gridded precipitation polygon generator and exporter 508. The depicted workflow also includes or involves an ensemble forecast wind speed footprint creator 510, an ensemble storm data extractor 512, an ensemble Rankine vortex wind speed generator 514, an ensemble gridded wind speed analysis creator 516, and an ensemble gridded wind speed polygon generator and exporter 518. The depicted workflow further includes an ensemble forecast probabilistic calculator 520, an ensemble forecast gridded wind speed data ingestor 522, an ensemble forecast gridded wind speed probability calculator 524, and an ensemble wind speed probability polygon generator and exporter 526. Each of these components/elements are related to one another as depicted in the illustrated implementation.

The workflow represented in FIG. 5 may be repeated for each active tropical cyclone, and/or for each corrected individual ensemble forecast member that has a forecast for the respective tropical cyclone.

The represented workflow has the TCEFS 106 generating precipitation footprints (see 502).

The first portion of a typical precipitation footprint generation process includes extracting (at 504) the respective data source. This may involve, for example, accessing CSV or other delimited data files of precipitation data stored in the ensemble forecast and metadata storage 220 for each individual ensemble member forecast. These data files may contain gridded precipitation accumulation information for all forecast hours of the individual ensemble members. Generally, this precipitation data does not go through the point intensity correction process steps, but instead, is a direct ensemble forecast extraction of raw ensemble forecast data stored in the ensemble forecast and metadata storage 220.

Following data extraction, precipitation data is isolated to only represent accumulated precipitation associated with the active tropical system of interest. One exemplary method for doing this is by first looping through each individual ensemble forecast and extracting the center point for the requested tropical cyclone system at each forecast hour. Then, using the extracted center point, the gridded precipitation data is extracted surrounding the center point at every forecast hour for the individual ensemble forecast.

Once individual forecast hours are extracted for each individual ensemble forecast, point-by-point gridded time interpolations and summations are created for distinct forecast intervals, such as 0 to 48 hour accumulations (see 506). The data can be time-interpolated on distinct hourly intervals to provide higher quality footprints that are continuous across the various generated accumulation intervals. These distinct accumulation intervals are stored in a separate set of variables in RAM, or other temporary storage, and passed on to the geospatial polygon generator and exporter component (see 508).

Geospatial (GeoJSON) polygons may be generated by first aggregating gridded points of common accumulation amounts together and binning them into distinct accumulation buckets. This gives the ability to contour commonly binned values together to create multi-polygon GeoJSON files, where each polygon created represents a distinct range of precipitation accumulation values (in the requested unit, such as inches or millimeters). These multi-polygon GeoJSON files may be generated for each individual ensemble forecast system per active tropical system, and then passed back to the initial creator process (see 528), which loads them into the relational database 220.

The represented workflow has the TCEFS 106 generating wind speed footprints (see 510).

The first portion of a typical wind speed footprint generation process includes the extraction (by 512) of the corrected maximum sustained wind speed data on a per individual ensemble forecast basis. This data may have been passed into the overall footprint generator process by the previous forecast corrector components via storage at the ensemble forecast and metadata storage 220. Additionally, the central minimum pressure data may be extracted from the ingested CSVs stored on Ensemble Forecast and Metadata Storage for use in generating a spatial pressure profile representing the storm at each forecast hour for each individual ensemble member.

From the passed-in corrected central minimum pressure and maximum sustained wind speed data, each individual forecast member is looped through for each active tropical system to generate a vortex representation of the tropical system at each valid forecast time. In one exemplary embodiment, the 2-dimensional pressure-wind Rankine vortex representation of the forecasted tropical cyclone's wind field is created (see 514) for each individual ensemble member at each forecast time. The Rankine vortex is an idealized vortex that employs pressure-to-wind relationships. First, in a typical implementation, the system creates an idealized 2-dimensional MSLP representation of the tropical system of interest. This pressure field can be created from the environmental pressure as estimated in the previous methodologies, the tropical systems central corrected central minimum pressure from the correction steps, and the storm's position (e.g., latitude and longitude). Then, the relationship between pressure and wind speed may be applied to obtain the idealized spatial representation of the near-surface wind field. This wind field may be then adjusted both spatially and in magnitude using the forecast storm speed and direction. These adjustments for speed and direction help represent commonly observed asymmetries in the wind field due to a tropical cyclones movement within its environment.

After individual forecast hour gridded wind speed information is generated by the TCEFS 106 (see 516) for each individual ensemble forecast, point-by-point gridded time interpolations and maximums are calculated by the TCEFS 106 for distinct forecast intervals, such as 0 to 48 hour maximum sustained wind speeds. The data may be time-interpolated on distinct hourly intervals to provide higher quality footprints that are continuous across the various generated maximum wind speed time intervals. These distinct intervals may be stored in a separate set of variables in RAM, or other temporary storage medium, and passed on to the geospatial polygon generator and exporter component (518).

Geospatial (such as GeoJSON) polygons may be generated by first aggregating gridded points of common maximum wind speed values together and binning them into distinct accumulation buckets. This enables the ability to contour commonly binned values together to create a multi-level GeoJSON polygon, where each polygon created represents a distinct range of wind speeds (in the requested unit, such as mph or km/h). These multi-polygon GeoJSON files are generated for each individual ensemble forecast system per active tropical system, and then passed back to the initial creator process (at 528) for loading into the relational database 220.

The workflow represented in FIG. 5 has the TCEFS 106 calculating probabilistic wind speed (see 520).

More particularly, after gridded wind speed representations for each active storm are created by each individual ensemble member, probabilistic wind speed information can be also generated (see 520). This information includes the probability of reaching tropical storm force winds or hurricane force winds at various points within the extent of the tropical system of interest. For each active tropical system, probabilistic wind speed information may be created based off the culmination of all the corrected ensemble forecast data, including the best skill member developed by the ideal blended forecast creator 236.

The process represented in FIG. 5 includes ingesting (522) the gridded wind speed data generated via the ensemble forecast wind speed footprint creator process (see 502). In some implementations, all ensemble member data is loaded into the calculator for each tropical cyclone for every spatial point at every forecast hour within the extent of the tropical system of interest. Then, for each forecast hour for each active tropical system, the probabilities of wind speeds reaching the specific threshold (tropical storm or hurricane) is calculated (524) at every grid point within the respective storm's spatial extent. The probability is calculated by aggregating the forecasted wind speed from each individual forecast member at every single spatial grid point for each forecast period of interest. These forecasted magnitudes are then compared to the threshold of interest to determine if they are at or exceed the specific threshold. The number of ensemble forecasts that are at or exceed the threshold are then divided by the total number of ensemble forecasts, yielding the percentage (or probability) that at that particular forecast hour, the wind speeds will exceed the threshold of interest. This gridded information is then aggregated and binned into 10% probability buckets, and then converted (526) to a multi-polygon GeoJSON files to be subsequently loaded into the relational database 220.

Referring again to FIG. 2, in a typical implementation, the data extraction and distribution layer process 242 begins with the output of the ensemble forecast wind speed and precipitation footprint creator 238, which is stored in a relational database 220, hosted locally or remotely. In one exemplary embodiment, the outputted data is stored in a PostgreSQL database (which the relational database 220 may be) hosted through a cloud-based hosting service. The data may be accessed through applications servers using queries identifying a particular named tropical system, such as a forecast initialization time, a storm name, or both, for example.

A variety of methods may be used to optimize the interaction between the application servers and queries to the database, depending on the types of servers and database utilized. For example, in one exemplary embodiment, the applications servers are Java based and interact with data efficiently by utilizing a Hibernate™ data mapping layer. The phrase Hibernate™ data mapping layer refers generally to an object-relational mapping tool for the Java programming language. It generally provides a framework for mapping an object-oriented domain model to a relational database (e.g., 220). In some implementations, a Hibernate™ data mapping layer solves object-relational impedance mismatch problems by replacing direct, persistent database accesses with high-level object handling functions.

Access to the data can be provided in a variety of ways. One exemplary embodiment allows a user to hit a RESTful (representational state transfer) API (application program interface) endpoint to retrieve the data through Java based database queries. The phrase representational state transfer (RESTful) refers to web services refers that provide is a way of providing interoperability between computer systems on the Internet. RESTful-compliant web services may, for example, allow requesting systems to access and manipulate textual representations of web resources or the like using a uniform and predefined set of stateless operations. By making use of a stateless protocol and standard operations, RESTful systems generally aim for fast performance, reliability, and the ability to grow, by re-using components that can be managed and updated without affecting the system as a whole, even while it is running. In a typical implementation, the API endpoints may be available for both the raw and bias-corrected data.

Data may be returned through these endpoints in a variety of formats for presenting to a user (e.g., via a user application 244). One exemplary embodiment returns data such as storm name, maximum wind speeds, minimum pressure, and storm basin in a JSON (JavaScript object notation) format, but other embodiments could return data in .xml or CSV formats. Wind and precipitation swath data is also returnable from the relational database 220 via REST endpoints, and in this embodiment, may be returned in GeoJSON (a geographic data structure) format.

The System may include a Graphical User Interface (“GUI”) 246 and/or may include the ability to output data from the Data Extraction and Distribution Layer 242 to the GUI, which allows visualization of the data and user-friendly toggling between different forecast time horizons, data parameters, etc.

The GUI 246 may include a user-facing computer rendered interface, hosted either locally on a user's computer or workstation or remotely. In the case of local GUIs, the GUI may include a feature to query the relational database containing the raw and bias-corrected data, which could be similar to one exemplary embodiment's ability to allow a user to hit REST endpoints to retrieve data through Java-based database queries.

If the GUI 246 is hosted remotely, the user may access the GUI through a communications device connected to the remote host. In one exemplary embodiment, the data is displayed to a user through an in-browser web application, built in HTML, CSS and JavaScript and using the MapBox map interface. The user chooses from the four most recent forecasts, which run every six hours, and is shown a list of current hurricane events at the time of the forecast. Other embodiments could include options for additional numbers of recent forecasts or historical forecasts.

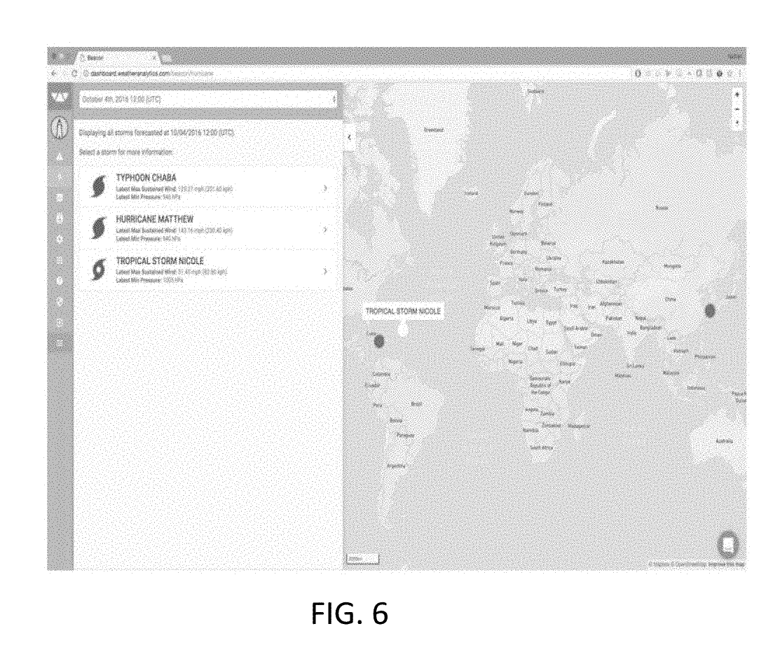

In one exemplary embodiment, as depicted in FIG. 6, the system may place color-coded pins (e.g., orange and white pins, indicating storm severity) on a map to show the storms' approximate location. The illustrated screen shot includes a listing of active tropical cyclones on the left and the map (showing the tropical cyclone locations and color-coding) on the right. The listing of active tropical cyclones specifies characteristics of each storm (e.g., latest maximum sustained wind and latest minimum pressure). In a typical implementation, selecting one of the indicated storms (either in the listing or on the map) causes the system to show or provide access to more information (including, e.g., information about the ideal blended forecast) about the selected tropical cyclone.

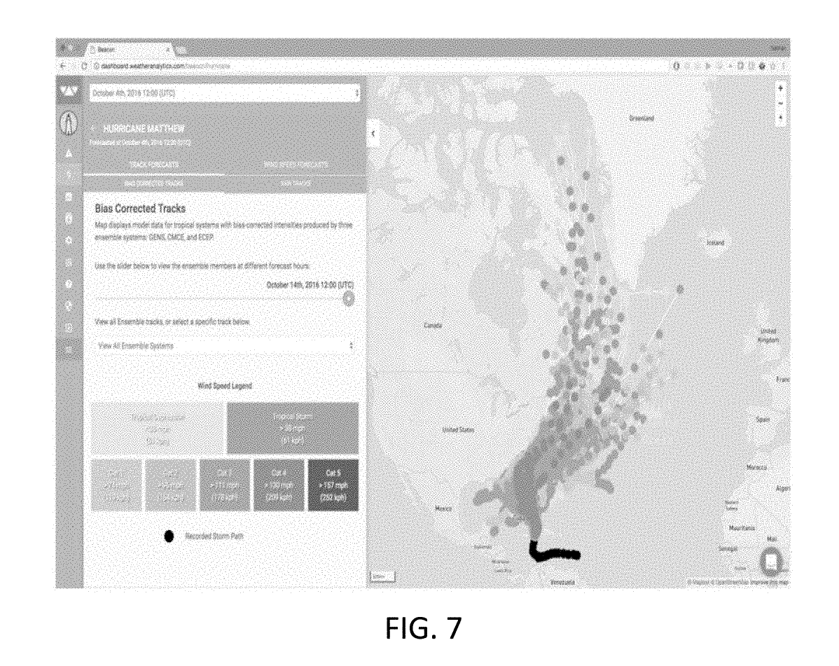

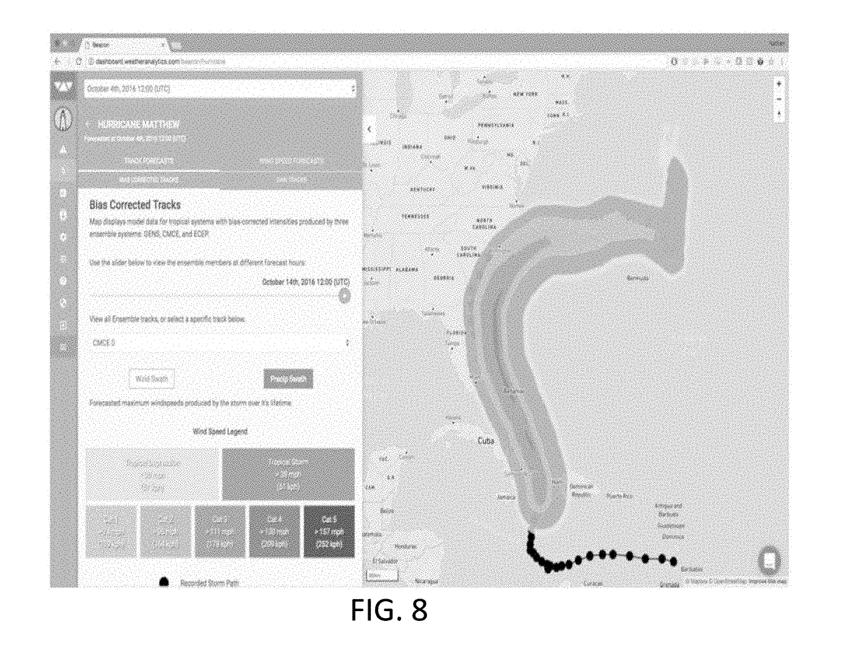

Once a tropical system of interest has been selected, the user can toggle between “Track” forecasts of where the storm is headed (FIG. 7) and “Wind Speed” forecasts showing the likelihood of both tropical storm and hurricane strength winds at different locations (FIG. 8).

The exemplary screenshot of FIG. 7 includes information about a tropical cyclone named Hurricane Matthew. The map on the right includes forecast tracks (for a plurality of forecasts, which are bias-corrected tracks). There are toggle buttons on the left that enable a user to toggle between track forecasts, wind speed forecasts, bias corrected tracks (as shown), and/or raw tracks. For the illustrated bias corrected tracks, the map displays model data for tropical systems with bias-corrected intensities produced by three ensemble systems: GENS, CMCE, and ECEP. A slider is provided that enables a user to view the ensemble members at different forecast hours. Moreover, there is a drop down menu that enables a user to view all ensemble tracks or select a specific track. There is also a color-coded wind speed legend that corresponds to color-coding in the map. Finally, the map shows (with dark dots) the locations corresponding to the recorded storm path. The GUI's ability to toggle between raw and corrected tracks with a superimposed recorded storm path, allows a user to quickly gauge both the accuracy of various ensemble members as well as the efficacy of the corrections made by the TCEFS.

The exemplary screenshot of FIG. 8 also includes information about the tropical cyclone named Hurricane Matthew. In particular, the screenshot shows information about the specific bias-corrected version of the CMCE 0 ensemble. There are options provided to view wind swaths and precipitation swaths. The map includes forecast data as well as recorded storm path data.

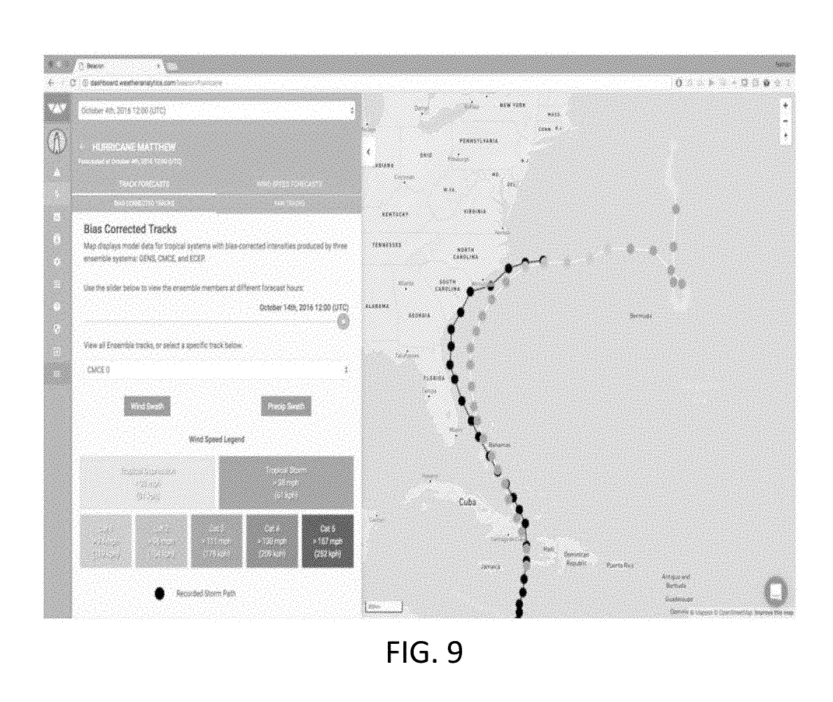

The exemplary screenshot of FIG. 9 has a map with a bias corrected track and historical tracking information for a tropical cyclone, Hurricane Matthew, based on the CMCE 0 data. The tracks are color coded to show wind speed, but could be color-coded or otherwise visually presented to include intensity-type data.

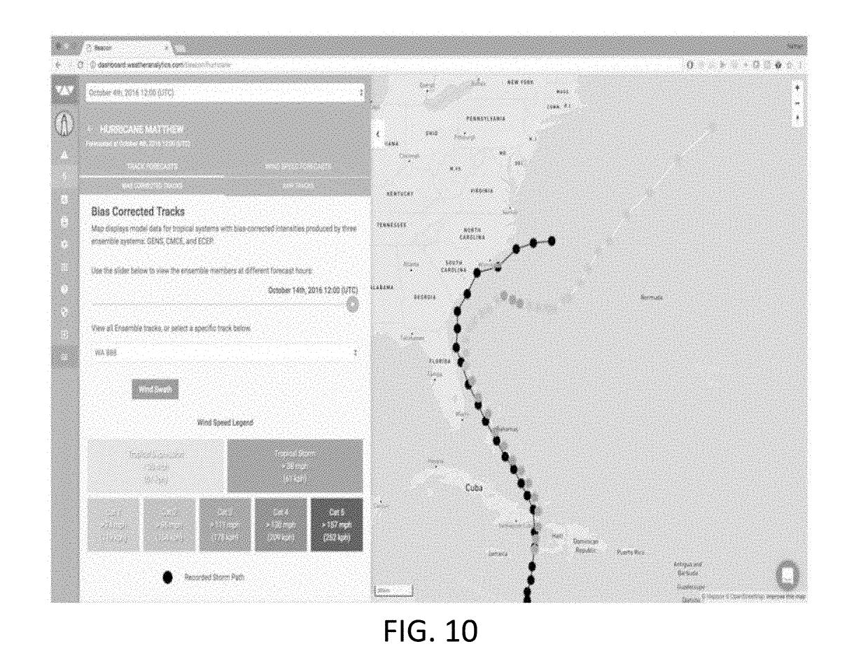

The exemplary screenshot in FIG. 10 has a map with a bias corrected track and historical tracking information for a tropical cyclone, Hurricane Matthew, showing the ideal blended forecast track. The tracks are color coded to show wind speed, but could be color-coded or otherwise visually presented to include intensity-type data.

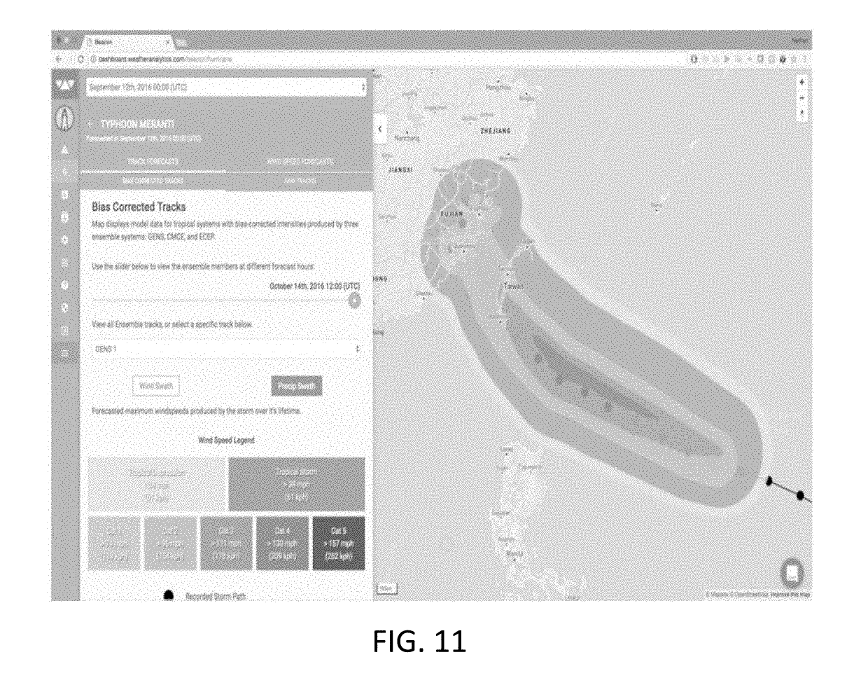

The exemplary screenshot in FIG. 11 has a map with a bias corrected track and historical tracking information for a tropical cyclone, Hurricane Matthew, based on GENS 1 data. The tracks are color coded to show wind speed, but could be color-coded or otherwise visually presented to include intensity-type data.

Typically, the user can use a slider tool (as shown in the illustrated screenshots), for example, to move through probabilities and tracks at different times in the forecast, up to 240 hours from when the forecast was created. Individual ensemble forecasts (and related information) can be singled out (FIG. 9), as can the “ideal” blended forecast (FIG. 10), to display forecasted track and intensity point information in addition to intensity footprints.

When viewing previous forecast information, any available historical location data for the storm also may be plotted on the map utilizing the metadata stored in the relational database 220 and passed through the data extraction and distribution layer 242. This may allow or enable a user to see both a particular tropical system's historical location and intensity as well providing subjective analysis of how accurately ensemble forecasts have predicted the observed storm track and intensity (FIG. 11). All swaths and map overlays include mouse hover events for additional information and legends indicating wind speed, probability and precipitation thresholds.

Unless otherwise apparent, this application uses common definitions of the Saffir-Simpson scale for tropical cyclones (see, e.g., http.//www.nhc.noaa.gov/aboutshws.php.), with extended definitions for tropical storm and depression. It is worth noting that there are numerous classification schemes, depending on basin.

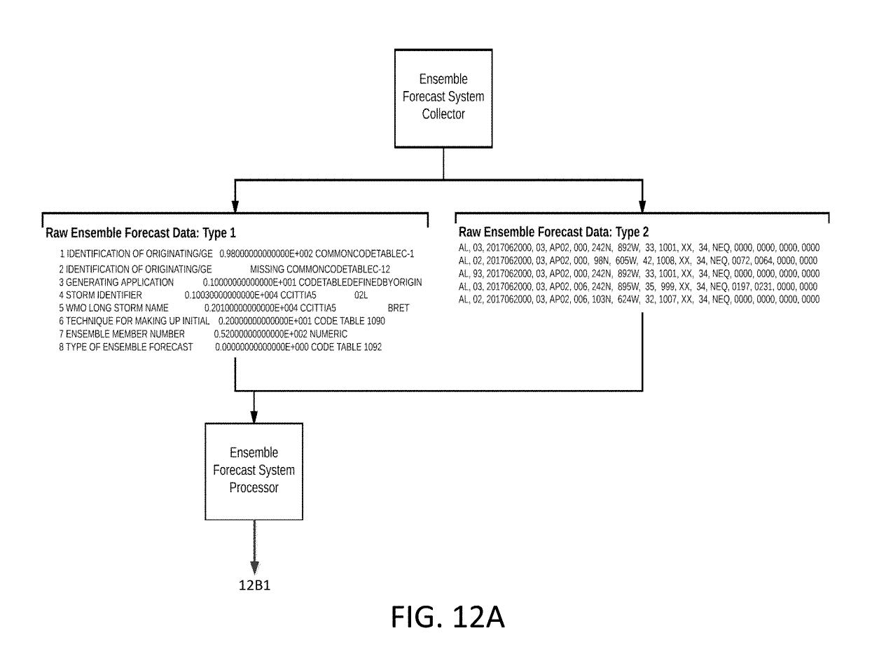

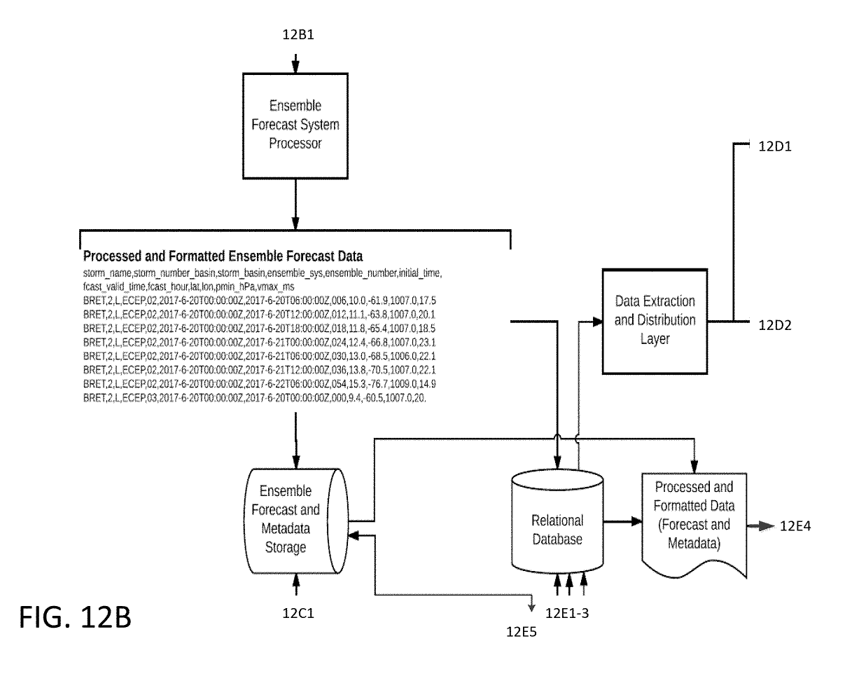

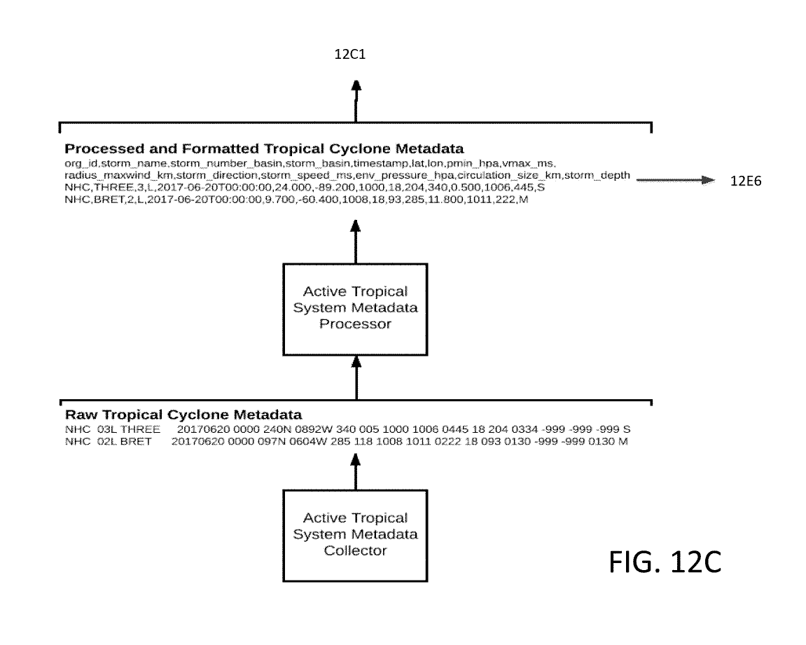

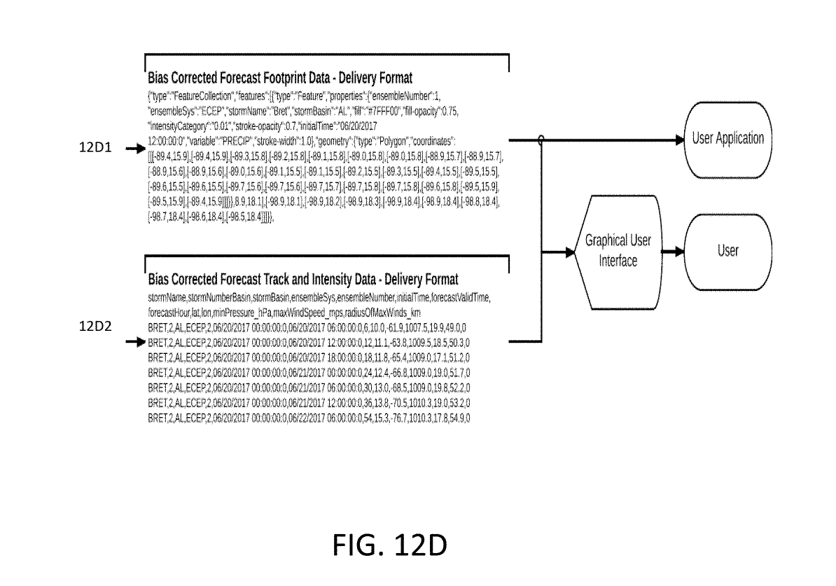

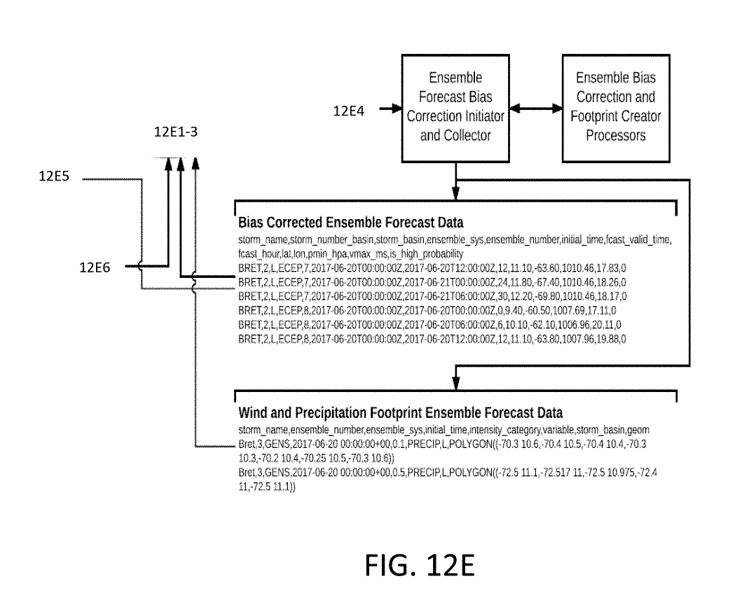

FIGS. 12A-12E are schematic representations showing aspects of an exemplary workflow of a TCEFS (e.g., 106) with examples of what portions of the data passing through parts of the TCEFS might look like.

A number of embodiments of the invention have been described. Nevertheless, it will be understood that various modifications may be made without departing from the spirit and scope of the invention.

For example, the various modules or components (e.g., of the TCEFS 106) disclosed herein can be implemented as virtually any kind of computer-based module or component (e.g., implemented in hardware, or in hardware executing appropriate software).

The relational database disclosed herein can be virtually any kind of relational database (e.g., implemented in a computer hardware memory storage platform or in software stored and/or executing on a computer hardware based platform). In a general sense, a relational database may include, for example, data stored in a manner to recognize relationships among the stored data. In one exemplary implementation, a relational database may organize data into one or more tables (or “relations”) of columns and rows, with a unique key identifying each row, for example.

Generally, each table/relation may represent one type of entity or element. The rows may represent instances of that type of entity or element and the columns representing values attributed to that instance.

An exemplary configuration of modules or components within the TCEFS 106 is disclosed, for example, in FIG. 2 herein. In some implementations, two or more of the disclosed modules or components, or their associated functionalities, may be combined into one single module or component. Moreover, in some implementations, one or more of the modules or components may be eliminated. Additionally, in some implementations, the connections between the modules or components may be modified and/or one or more of them may be dispensed with.

The system, TCEFS, its associated functionalities, and technologies may be useful to a wide variety of individuals and/or organizations. One such exemplary user-base would be governmental agencies and non-governmental agencies that are charged with the responsibilities of predicting, publicizing and responding to the effects of damaging tropical cyclones. The superior wind and precipitation forecasts provided by the disclosures herein may allow these entities to better inform the public of potential disasters and deploy resources more efficiently, both before and after a storm, and to expedite and improve efficiency of cleanup and recovery. In addition, insurer and re-insurers might benefit from the improved forecasts and cyclone visualizations to better plan for and manage for losses (e.g., large portfolio losses), including, for example, deploying additional adjusters to potentially affected areas.

The ensemble forecast and metadata storage may be or consist of any kind of electronic storage or computer-based memory storage device or devices and may be hosted locally or remotely. The relational database may be or consist of any kind of electronic or computer-based database, one example of which is a PostgreSQL database. Software systems used to maintain relational databases are generally known as relational database management systems (RDBMS), which typically utilize Structured Query Language (SQL) as the language for querying and maintaining the database.

The Ensemble Forecast System Collector and Processor components can contain one or multiple (and number of) collector and processor instances as necessary to collect and process data from the storm forecast distribution repositories (multiple agencies).

The storm forecast distribution repository 102 can be virtually any kind of computer-implemented memory storage, hosted locally or remotely relative to the TCEFS. Moreover, it can include data from any number of sources/storm forecasting agencies. Likewise, the active tropical system metadata repository can be virtually any kind of computer-implemented memory storage, hosted locally or remotely relative to the TCEFS. Moreover, it can include human-observed data, machine-observed data, and/or both.

The various data collection and processing functionalities disclosed herein can be implemented according to any kind of timeline or schedule. In some implementations, one or more (or all) of the processes may be conducted in real time, in near real time, immediately, etc. Unless otherwise indicated, words and phrases like “in real time,” “in near real time,” “immediately,” and the like should be construed to mean quickly (e.g., without introducing any deliberate delay by the participating computer components). So, for example, in some implementations, the system collects data (e.g., metadata and forecast data) from external surfaces either in real time or near real time. This may mean that the system collects data as it becomes available, which for some data sources may be at 6 or 12 hour intervals. In that case, the system may be configured to collect data at least every 6 or 12 hours, as the case may be.

The data collection (e.g., the collecting of metadata and/or forecast data) can be accomplished in a number of possible ways (e.g., across various communication ports and/or web-enabled interfaces). In some implementations, for example, the data may be downloaded from the external data source (e.g., one or multiple agencies and/or repositories, etc.). In some implementations, for example, the data may be pushed to the tropical cyclone ensemble forecasting system (TCEFS) from the data source. Some implementations may include a combination of pushing and downloading.

The TCEFS may receive input information from one or more of a variety of different sources, including those specifically mentioned herein, as well as others. Additionally, the TCEFS may be configured to output (or make available to users) the data it produces, and make that data easy for a user to leverage, in a variety of different ways. The TCEFS may be configured to take into account one or more (or all) of the weather-related data mentioned herein, as well as, perhaps, other weather-related data that may not have been explicitly mentioned herein. The TCEI'S may be configured and adapted to forecast all kinds of tropical cyclones and the like.

The word “ideal” as used in “ideal blended forecast,” for example, generally refers to the idea of being best possible or best produced. To be “ideal” does not require absolute perfection. Best can mean, for example, highest accuracy in terms of one or more characteristics (e.g., most accurate position forecasting, wind speed forecasting, pressure forecasting, etc.).

In exemplary embodiments, the results of some of the processes disclosed herein include a set of 94quality-controlled 10-day forecasts at 00 and 12 UTC, and 21 ensemble forecasts at 06 and 18 UTC, for every day there is an active tropical system, in addition to an idealized blended forecast. Using individual forecast information, an “ideal” forecast is generated that represents the most likely forecast solution at the time of forecast generation. The ideal forecast can, and in some exemplary embodiments does, include a weighting methodology so that the ideal forecast is a weighted blend of the individual ensemble forecast members based on their proficiency in forecasting the active tropical cyclone of interest. After the System generates corrected track and intensity point forecasts, this information may be passed into a component to generate three-dimensional (space and time) wind speed and precipitation accumulation footprints. These footprints represent the spatial extent of a tropical cyclone's wind speeds or rainfall amounts for the length of the 10-day forecast. These footprints can be generated for each individual ensemble forecast for an active tropical system, including the ideal blended forecast. The aforementioned point and geospatial footprint forecast data may be stored and then made available to end users through the data extraction layer. The data extraction layer can deliver the footprint forecast data in multiple ways. In one exemplary embodiment, the footprints are stored in a relational database and made available to users through graphical user interfaces (GUIs) or via an Application Program Interface (API). In other embodiments, the data is stored in a relational database and extracted to allow external users to directly ingest the data into user-created interfaces.

In various embodiments, the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control (or controlling) the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Some of the operations described in this specification can be implemented as operations performed by a data processing apparatus (e.g., a processor) on data stored on one or more computer-readable storage devices or received from other sources. The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. While this specification contains many specific implementation details, these should not be construed as limitations on the scope of any inventions disclosed herein, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a described combination can in some cases be excised from the combination, and certain features disclosed may be combined into different subcombinations or variations thereof.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In various implementations, the functionalities disclosed herein and/or associated with the systems and technologies disclosed herein can be accessed from virtually any kind of electronic computing device(s), including, for example, desktop computers, laptops computers, smart phones, tablet, etc.

Any storage media referred to herein can be or include virtually any kind of media such as electronic, magnetic, optical, electromagnetic, infrared, or semiconductor system (or apparatus or device) or propagation media. Examples of suitable computer-readable media include semiconductor or solid-state memory, magnetic tape, removable computer diskettes, random access memory (RAM), read-only memory (ROM), rigid magnetic disks and/or optical disks.

In some implementations, certain functionalities described herein may be provided by a downloadable software application (i.e., an app) or in association with a website. Furthermore, some of the concepts disclosed herein can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The phrase computer-readable medium or computer-readable storage medium is intended to include at least all mediums that are eligible for patent protection, including, for example, non-transitory storage, and, in some instances, to specifically exclude all mediums that are non-statutory in nature to the extent that the exclusion is necessary for a claim that includes the computer-readable (storage) medium to be valid. Some or all of these computer-readable storage media can be non-transitory.

The phrase “tropical cyclone ensemble forecasting system” and the like should be construed broadly to include virtually any kind of computer-based system or technology that has functionality and/or a configuration the same as or similar to any of the functionalities or configurations disclosed herein.

Other implementations are within the scope of the claims.

What is claimed is:

1. A method comprising:
receiving, at a computer-based tropical cyclone ensemble forecasting system (TCEFS), a plurality of storm forecasts, directly or via one or more intermediaries, from a plurality of different storm forecasting agencies;
receiving, at the TCEFS, storm-related metadata from the plurality of different storm forecasting agencies;
pairing the storm-related metadata to the plurality of storm forecasts;
adjusting the storm forecasts based on the paired storm-related metadata and other forecast data;
producing an ideal blended storm forecast based on the corrected storm forecasts; and
enabling a user to view and/or access information about at least the ideal blended storm forecast at a user interface.

2. The method of claim 1, wherein each storm forecast represents a weather prediction created by integrating a mathematical representation of physical equations governing the atmosphere forward in time from a starting point of initial meteorological conditions; and
each item of the storm-related metadata represents an actual measurement or observation of a real-world event that has occurred.

3. The method of claim 1, wherein receiving the plurality of storm forecasts comprises:
periodically querying for new storm forecast data from a plurality of forecast system collector instances of the TCEFS,
wherein each forecast system collector instance corresponds to a different storm forecasting agency and is particularly configured to behave according to requirements and/or characteristics of the corresponding weather agency; and
processing each received storm forecast with a particular one of a plurality of forecast system processor instances, wherein each forecast system processor instance corresponds to one of the forecast system collector instances.

4. The method of claim 1, further comprising: determining, for each metadata file received at the TCEFS, whether the file size is zero; and
if the file size is determined to be zero, then suspending operations with respect to that file.

5. The method of claim 1, further comprising:
resolving disparities between and among the storm forecasts by leveraging commonalities in the storm forecasts and/or metadata to eliminate one or more of the disparities.

6. The method of claim 1, further comprising:
categorizing the metadata with an active tropical systems metadata processor of the TCEFS.

7. The method of claim 1, wherein the pairing comprises resolving conflicts, filling in missing information, and/or consolidating duplicated information between and among the storm forecasts and the storm-related metadata.

8. The method of claim 1, wherein the pairing comprises trying to identify common features or characteristics across the different data sets to identify which data sets relate to the same tropical cyclones.

9. The method of claim 1, wherein adjusting the storm forecasts based on the paired storm-related metadata and other forecast data comprises:
extracting raw tropical cyclone ensemble forecast data related to each of the plurality of storm forecasts from a relational database; and
correcting initial intensity estimates for central minimum pressure of each of the tropical cyclones represented in the extracted raw tropical cyclone ensemble forecast data.

10. The method of claim 1, wherein adjusting the storm forecasts based on the paired storm-related metadata and other forecast data comprises:
correcting a tendency in each of the plurality of storm forecasts to under-predict intensification; and
calculating new maximum sustained wind speeds for each of the plurality of storm forecasts based on a relationship between central minimum pressure-to-maximum near-surface sustained wind.

11. The method of claim 1, wherein producing the ideal blended storm forecast based on the corrected storm forecasts comprises:
obtaining a full suite of the adjusted storm forecasts and actual observations of one or more storm characteristics over a period of time;
for each active storm, comparing each of the individual storm forecasts' historical forecast data to the actual observations of the one or more storm characteristics; and
calculating one or more errors metrics based on the comparison.

12. The method of claim 11, wherein producing the ideal blended storm forecast based on the corrected storm forecasts further comprises:
selecting which adjusted version of the plurality of storm forecasts to include in a blended forecast based on the one or more error metrics, or calculating weights to assign each in a blended forecast based on the one or more error metrics.

13. The method of claim 11, further comprising:
creating an ensemble forecast wind speed and/or precipitation footprint based on the ideal blended forecast.

14. The method of claim 1, wherein the ideal blended storm forecast is influenced by one or more skill scores assigned to each respective one of the plurality of storm forecasts in forecasting certain characteristics of a currently-active storm.

15. The method of claim 1, wherein enabling the user to view and/or access information about at least the ideal blended storm forecast at the user interface comprises:
enabling the user to toggle between track forecasts, bias corrected tracks, wind speed forecasts, raw tracks, the ideal blended storm forecast, and historical data for the storm; and/or
enabling the user to specify different forecast hours for viewing; and/or
enabling the user to view all ensemble tracks or select a particular one of the ensemble tracks.

16. The method of claim 1, wherein one or more of the plurality of storm forecasts are received via a storm forecast distribution repository, and
wherein one or more pieces of the plurality of weather-related metadata are received from an active tropical system metadata repository

17. The method of claim 1, wherein the user interface is a graphical user interface or a non-graphical user interface via an application programming interface (API).

18. The method of claim 1, wherein the plurality of storm forecasts come from a first subset of the plurality of different storm forecasting agencies, and
wherein the storm-related metadata comes from a second subset of the plurality of different storm forecasting agencies that is different than the first subset.

19. The method of claim 1, wherein the TCEFS comprises:
a computer-based processor, and
a computer-based memory coupled to the computer-based processor, wherein the computer-based memory stores instructions which, when executed by the computer-based processor, cause the computer-based processor to:
pair the storm-related metadata to the plurality of storm forecasts;
adjust the storm forecasts based on the paired storm-related metadata and the other forecast data;
produce the ideal blended storm forecast based on the corrected storm forecasts; and
enable the user to view and/or access information about at least the ideal blended storm forecast at the user interfaces.

20. A computer-based tropical cyclone ensemble forecasting system (TCEFS) configured to receive storm forecasts from a source of storm forecasts and storm-related metadata from a source of storm-related metadata, wherein the TCEFS comprises:
a computer-based processor, and
a computer-based memory coupled to the computer-based processor, wherein the computer-based memory stores instructions which, when executed by the computer-based processor, cause the computer-based processor to:
pair the storm-related metadata to the plurality of storm forecasts;
adjust the storm forecasts based on the paired storm-related metadata and other forecast data;
produce an ideal blended storm forecast based on the corrected storm forecasts; and
enable a user to view and/or access information about at least the ideal blended storm forecast at one or more of a plurality of computer-based user interfaces,
wherein each storm forecast represents a weather prediction based on correlated meteorological observations, and
wherein each item of the storm-related metadata represents an actual measurement or observation of a real-world event that has occurred.

21. The TCEFS of claim 20, wherein the computer-based processor is further configured to instantiate:
a plurality of forecast system collector instances configured to periodically query a source of storm forecasts, wherein each forecast system collector instance corresponds to a different one of the storm forecasting agencies and is particularly configured to behave according to requirements and/or characteristics of the corresponding weather agency; and
a plurality of forecast system processor instances, wherein each forecast system processor instance corresponds to one of the forecast system collector instances and is configured to process the storm forecasts received from the corresponding weather agency via the corresponding forecast system collector instance.

22. The TCEFS of claim 20, wherein the computer-based processor is further configured to resolve the disparities between and among the storm forecasts by leveraging commonalities in the storm forecasts and/or the metadata to eliminate one or more of the disparities.

23. The TCEFS of claim 20, wherein the computer-based processor is further configured to instantiate an active tropical system metadata processor to categorize the metadata.

24. The TCEFS of claim 20, wherein the computer-based processor is further configured to pair the storm-related metadata to the plurality of storm forecasts by:
resolving conflicts, filling in missing information, and/or consolidating duplicated information between and among the storm forecasts and the storm-related metadata, and/or
trying to identify common features or characteristics across the different data sets to identify which data sets relate to the same tropical cyclones.

25. The TCEFS of claim 20, wherein the computer-based processor is configured to adjust the storm forecasts based on the paired storm-related metadata and other forecast data by:
extracting raw tropical cyclone ensemble forecast data related to each of the plurality of storm forecasts from a relational database; and
correcting initial intensity estimates for central minimum pressure of each of the tropical cyclones represented in the extracted raw tropical cyclone ensemble forecast data.

26. The TCEFS of claim 20, wherein the computer-based processor is further configured to adjust the storm forecasts based on the paired storm-related metadata and other forecast data by:
correcting tendency in each of the plurality of storm forecasts to under-predict intensification; and
calculating new maximum sustained wind speeds for each of the plurality of storm forecasts based on relationship between central minimum pressure-to-maximum near-surface sustained wind.

27. The TCEFS of claim 25, wherein the computer-based processor produces the ideal blended storm forecast based on the corrected storm forecasts by:
obtaining a suite of the adjusted storm forecasts and actual observations of one or more storm characteristics over a period of time;
for each active storm, comparing each of the individual storm forecasts' historical forecast data to the actual observations of the one or more storm characteristics; and
calculating one or more errors metrics based on the comparison; and
selecting which adjusted version of the plurality of storm forecasts to include in a blended forecast based on the one or more error metrics, or
calculating weights to assign each in a blended forecast based on the one or more error metrics.

28. The TCEFS of claim 27, wherein the computer-based processor is further configured to create an ensemble forecast wind speed and/or precipitation footprint based on the ideal blended forecast.

29. The TCEFS of claim 20, wherein the ideal blended storm forecast is influenced by one or more skill scores assigned to each respective one of the plurality of storm forecasts in forecasting certain characteristics of a currently-active storm.

30. The TCEFS of claim 20, wherein the computer-based processor is configured to enable the user to view and/or access information about at least the ideal blended storm forecast at one or more of a plurality of computer-based user interfaces by:
enabling the user to toggle between track forecasts, bias corrected tracks, wind speed forecasts, raw tracks, the ideal blended forecast, and historical data for the storm; and/or
enabling the user to specify different forecast hours for viewing; and/or
enabling the user to view all ensemble tracks or select a particular one of the ensemble tracks.

31. The TCEFS of claim 20, wherein one or more of the plurality of storm forecasts are received via a storm forecast distribution repository, and wherein one or more pieces of the plurality of weather-related metadata are received from an active tropical system metadata repository

32. The TCEFS of claim 20, wherein the user interface is a graphical user interface or a non-graphical user interface via an application programming interface (API).

33. The TCEFS of claim 20, wherein the plurality of storm forecasts come from a first subset of a plurality of different storm forecasting agencies, and the storm-related metadata comes from a second subset of the plurality of different storm forecasting agencies, wherein the second subset is the same or different than the first subset.

34. A computer-based system for forecasting weather, the computer-based system comprising:
a source of storm forecasts from multiple storm forecasting agencies;
a source of storm-related metadata of actual weather-related observations or measurements;
a computer-based tropical cyclone ensemble forecasting system (TCEFS) configured to receive storm forecasts from the source of storm forecasts and storm-related metadata from the source of storm-related metadata; and
one or more computer-based user interfaces to access data from the computer-based tropical cyclone ensemble forecasting system,
wherein the TCEFS comprises a computer-based processor, and a computer-based memory that stores instructions which, when executed by the computer-based processor, cause the computer-based processor to:
pair the storm-related metadata to the plurality of storm forecasts;
adjust the storm forecasts based on the paired storm-related metadata and other forecast data;
produce an ideal blended storm forecast based on the corrected storm forecasts; and
enable a user to view and/or access information about at least the ideal blended storm forecast at one or more of the computer-based user interfaces,
wherein each storm forecast represents a weather prediction based on correlated meteorological observations, and
wherein each item of the storm-related metadata represents an actual measurement or observation of a real-world event that has occurred.
